(19) United States
(12) Patent Application Publication
(10) Pub. No.: US 2001/0039576 A1
(43) Pub. Date: Nov. 8, 2001

(54) Network policy transmission method from policy server to network node

(76) Inventor: Yasusi Kanada, Tokyo (JP)

Correspondence Address: MATTINGLY, STANGER & MALUR, P. C., 104 East Hume Avenue, Alexandria, VA, 22301, US

(21) Appl. No.: 09/730,577

(22) Filed: Dec. 7, 2000

(30) Foreign Application Priority Data
Dec. 19, 1999 (JP) 11-351116

(51) Int. Cl. G06F 15/173

(52) U.S. Cl. 709/223; 709/244

(57) ABSTRACT

A policy server assigns an identifier to each of a plurality of policy rules in each of which condition and action are described and transmits these policy rules to a network node. When transmitting new policy rules to the network node as additional ones, the server detects policy rules that depend on a newly entered policy rule or on which a newly entered policy rule depends. As for the policy rules that depend on a new policy rule or on any of which a new policy rule depends, if the policy rule has not been transmitted to the network node, the identifier thereof and the condition and action described therein are transmitted to the network node; if the policy rule has been transmitted to said network node, the identifier thereof is transmitted to the network node, but the condition and action described therein are not transmitted.

### BACKGROUND OF THE INVENTION

1. Field of the Invention

The present invention relates to methods of controlling Quality of Service (QoS) over a network such as the Internet in which routers and other network nodes that are controllable on a policy basis are interconnected by media and methods of running distributed rule-based programs over a network in which nodes on which rule-based programs can run are interconnected by media.

2. Description of Related Art

Policy control methods for networks are mentioned as first previous art related to the present invention. The policy control methods for networks are studied and discussed by the Internet Engineering Task Force (IETF) and other similar associations. The following article gives an overview of the policy control methods:

“Commercial Production of Policy Server Started” in the June issue, 1999 of Nikkei Internet Technology, pp. 144-151.

In particular, a policy-based QoS control method is discussed in “White Paper—Introduction to QoS Policies”, http://www.stardust.com/, 1998.

In a network system to which policy control is not applied, every networked device must be set up separately to fall under the control of network administrating services such as QoS management (service quality management) and security management of the devices in the network. On the other hand, in a network system to which policy control is applied, by specifying setup policies on a computer called a policy server, all devices in the network can be set up accordingly, only requiring the input of a small quantity of information. Such network administrative method enables control duties over the network that is too complicated for human operators to exercise, such as policy change in minute time steps specified and dynamic policy update when requested from an application program.

A policy is normally described as a sequence of rules called policy rules. A policy rule is a condition-action type rule. This means that action to take if a condition is true is described as a rule.

There is a plurality of candidate protocols for deploying policies to routers; a typical one is a Common Open Policy Service (COPS) protocol. In the IETF, the proposals of the COPS protocol were made by:

J. Boyle, et al., The COPS (Common Open Policy Service) Protocol, draft-ietf-rp-cops-08.txt (http://www.itef.org/internet-drafts/draft-ietf-rap-cops-08.txt), Internet Draft, IETF, 1999; and

F. Reichmeyer, et al., COPS Usage for Policy Provisioning, draft-ietf-rap-pr-01.txt (http://www.itef.org/internet-drafts/draft-ietf-rap-pr-01.txt), Internet Draft, IETF, 1999.

As regards the policy notation to be used when downloading policies, Policy Information Bases (PIB) have been proposed. An example thereof was given by:

M. Fine, et al., Quality of Service Policy Information base, draft-mfine-cops-pib-02.txt <http://www.itef.org/internet-drafts/draft-mfine-cops-pib-02.txt>, Internet Draft, IETF, 1999.

A Differentiated Services technique (hereinafter referred to as a DiffServ technique) is mentioned as second previous art related to the present invention. The DiffServ technique is used to assure service quality, namely QoS over the Internet. The study efforts concerning the DiffServ technique were reported by:

S. Blake, et al., An Architecture for Differentiated Services, RFC 2475, IETF, 1998; and

K. Nichols, et al., A Two-bit Differentiated Services Architecture for the Internet, RFC 2638, IETF, 1999.

In the DiffServ technique, when a series of packets is transmitted from a first network application on a device to a second network application on another device via a network, the packets are regarded as belonging to a single “flow”, that is, a flow of the serial packets. Determining an IP packet belonging to a flow can be made by the source and destination IP addresses of the IP packet and the protocol for transmitting it; moreover, by identifying the ports used for its transmission if the protocol is TCP or UDP.

The path from the first network application to the second network application is set up through a first edge router as the entrance to the network, 0 or one or more core routers, and a second edge router as the exit from the network.

At the entrance edge router on this path, the DiffServ technique assembles a plurality of flows into one flow with a specific value for marking being set in the Differentiated Services (DS) field of the packets assembled in the flow. After that, the packets having this value are treated together as one flow (called an aggregated flow) The value contained in the DS field is called a Differentiated Services CodePoint (DSCP). By generating aggregated flows, core routers can control QoS conditions such as bandwidth and packet transmission priority per aggregated flow by the judgment according to the DSCP only. If flows are aggregated by using the DiffServ technique, the core routers can identify a sequence of packets by referring to the DSCP only and the load of the core routers for controlling QoS conditions can be reduced.

For some DSCP values for DiffServ, standard behavior regarding QoS (Pre-hop behavior, PHB) is predetermined to take place when a specific DSCP is given. Expedited Forwarding (EF) is behavior like a virtual private line, specified in RFC2598 of IETF. A recommended DSCP value that causes the EF is 46. Assured Forwarding (AF) is framing for which one of a plurality of services of different behavior can be defined, specified in RFC 2597 of IETF. Best Effort (BE) is behavior compatible with the previous, a DSCP value of 0 is assigned to it.

### SUMMARY OF THE INVENTION

In principle, either a block of the above-mentioned policy rules or a single rule may be downloaded. In the PIB, all parts of the PIB including a policy rule and its components are assigned their identifiers. As a general rule, therefore, a discrete rule can be specified to be added, removed, or updated. In actuality, however, adding, removing, or updating a single rule or its subdivision may cause the failure of intended action. There are two reasons why adding, removing, or updating a single rule results in failure. First reason is that rules are generally interdependent and adding, removing, or updating a rule changes the meaning of another rule that depends on the rule. Second reason is that even if rules are essentially not interdependent, batch processing of a plurality of rules by a router may result in some interdependence. When, for example, rules downloaded from a policy server are converted into those in form that they can be executed on a router, it is required that a plurality of rules are merged into one rule, or inversely, one rule is broken down into a plurality of rules. If one of the rules to be merged is removed or updated, the remaining rules must be reconverted accordingly.

To avoid the problem that addition, deletion, or update of a single rule is substantially impossible to do, some previous policy server always downloads a block of policies. For a network system architectured to download a block of policies, however, download is time-consuming if there are many policy rules and for some type of router, it is possible that policy control is disabled throughout some long download.

The same problem arises when the DiffServ technique is implemented. This is because rule-based programs, namely, policy rules are used and controlled by a policy server to execute the above-described marking and controlling QoS conditions.

In order to add, remove, or update rules successively within the framework of the DiffServ technique, the following reference asserts that all rules must be modular, that is, they must be free to be rearranged in any combinations and the requirement for that all rules are independent is that the condition defined in any rule must be exclusive:

Y. Kanada, et al., NSMP-based QoS programming Interface MIB for Routers, draft-kanda-diffserv-qospifmib-00.txt (http://www.ietf.org/internet-drafts/draft-kanada-diffser v-qospifmib-00.txt), IETF, 1999.

However, this reference does not state that: (1) how processing is performed if a non-exclusive condition is specified; (2) what means should be taken if interdependence between rules exists due to some reason other than non-exclusive conditions.

An object of the present invention is to reduce the number of rules and the data to be transferred from a policy server to a router when the policy server adds policy rules to, removes them from, or updates them on the router in a network system to which policy control is applied.

The above problem can be solved by the following means. Means of analyzing policy rules for dependence of policy rule data on another policy rule data is used to obtain minimum policy rules and data sets to be converted when the policy rules are converted into those in form that they can be executed on the router. When the policy server is requested to send a policy rule to the router, it judges whether the policy rule has been stored in the router. If the policy rule has been stored in the router, the policy server transfers only its identifier to the router instead of transferring its contents. In this way, the data quantity to be transferred can be minimized. Therefore, the present invention enables: checking traffic congestion in a network; minimizing the rule download time and the time required for policy rule conversion; eliminating policy control interruption or minimizing the interruption time; and preventing routers from being put under overload.

### BRIEF DESCRIPTION OF THE DRAWINGS

Other objects and advantages of the invention will become apparent during the following discussion of the accompanying drawings, wherein:

FIG. 1 is a schematic diagram of a network configured according to a preferred embodiment of the present invention;

FIG. 2 is a diagram showing the configuration of a policy server included in FIG. 1;

FIGS. 3A and 3B are illustrations of operator input templates of policy rules;

FIGS. 4A and 4B are illustrations as samples of the contents of a policy repository included in FIG. 2;

FIG. 5 is a flowchart illustrating the flow of processing to be performed by a policy input processor included in FIG. 2;

FIG. 6 is a flowchart illustrating the flow of processing to be performed by a policy consistency checker included in FIG. 2;

FIG. 7 is an illustration of sample contents of a policy schedule table included in FIG. 2;

FIG. 8 is a flowchart illustrating the flow of processing to be performed by a policy scheduler included in FIG. 2;

FIG. 9 is an illustration of sample contents of a network configuration management table included in FIG. 2;

FIG. 10 is a flowchart illustrating the flow of processing to be performed by a policy sender included in FIG. 2;

FIG. 11 is a diagram showing the configuration of a router included in FIG. 1;

FIG. 12 is a diagram showing the configuration of a network interface included in FIG. 11;

FIG. 13 is an illustration of sample contents of a policy source rule database (DB) included in FIG. 11;

FIG. 14A is an illustration of sample contents of a variable reference table included in FIG. 11;

FIG. 14B is a graphical representation of the contents of the variable reference table included in FIG. 11;

FIG. 15 is a flowchart illustrating the flow of processing to be performed by a policy receiver included in FIG. 11;

FIG. 16 a flowchart illustrating the flow of processing to be performed by a policy rule dependence analyzer included in FIG. 2;

FIG. 17 is an illustration of sample contents of a policy rule table included in FIG. 11;

FIG. 18 is an illustration of sample contents of a queue configuration table included in FIG. 11;

FIG. 19 is a flowchart illustrating the flow of processing to be performed by a policy rule compiler included in FIG. 11;

FIG. 20 is a flowchart illustrating the flow of a classification instruction generating process included in FIG. 19;

FIG. 21 is a flowchart illustrating the flow of a policing instruction generating process included in FIG. 19;

FIG. 22 is a flowchart illustrating the flow of a QoS action instruction generating process included in FIG. 19;

FIG. 23 is a flowchart illustrating the flow of a scheduling configuration generating process included in FIG. 19;

FIG. 24 is an illustration of sample formulated data to be transmitted between the policy server and the router included in FIG. 1;

FIG. 25A is a diagram showing the configuration of a proxy;

FIG. 25B is a diagram showing the configuration of another router;

FIG. 26 is an illustration of sample formulated data of transmission to be added to the sample formulated data of transmission shown in FIG. 24; and

FIG. 27 illustrates simplified operator input templates of policy rules.

### DESCRIPTION OF THE PREFERRED EMBODIMENTS

A preferred embodiment of the present invention will be explained below.

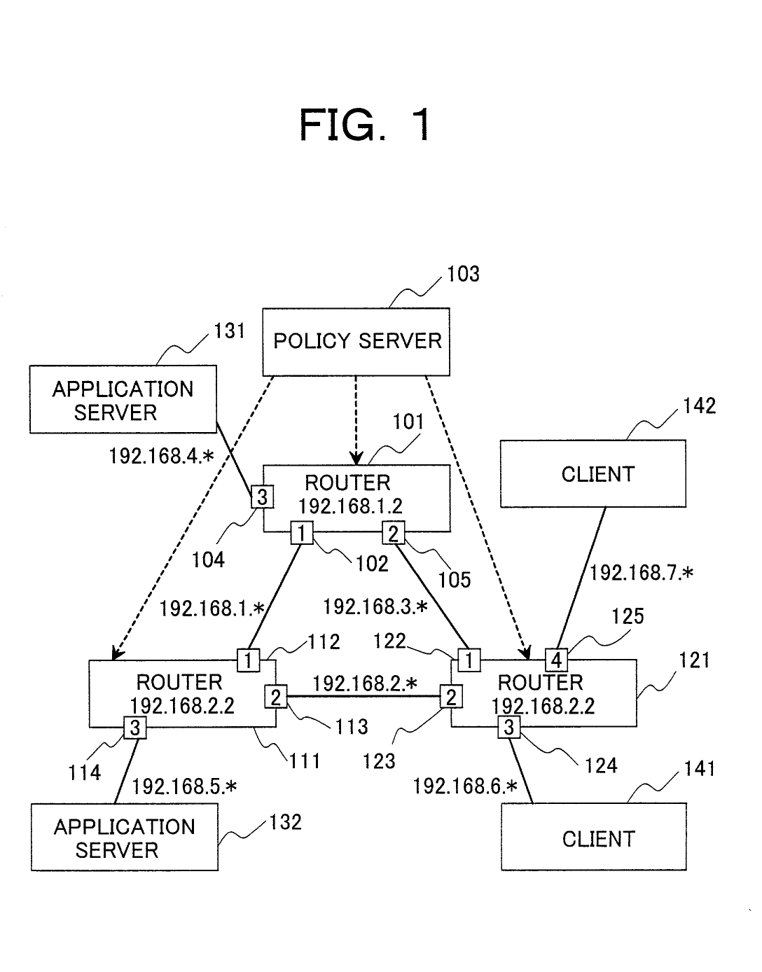

First, the configuration of a network configured for this embodiment will be described with reference to FIG. 1. This network is assumed to operate with the Internet protocol. The network is configured by connecting a router 101, a router 111, and a router 121 with lines such as fast Ethernet. A policy server 103 controls these routers 101, 111, and 121. To this network, an application server 131, an application server 132, and a client 141 and a client 142 that use these servers are connected. This configuration allows subscribers to use World Wide Web including MPEG picture and sound reproduction and multimedia data.

The router 101 is assigned IP address 192.168.1.2. The router 101 has network interfaces 102, 105, and 104. The network interface 102 is assigned interface number 1, the network interface 105 interface number 2, and the network interface 104 interface number 3.

The router 111 is assigned IP address 192.168.2.2. The router 111 has network interfaces 112, 113, and 114. The network interface 112 is assigned interface number 1, the network interface 113 interface number 2, and the network interface 114 interface number 3.

The router 121 is assigned IP address 192.168.3.2. The router 121 has network interfaces 122, 123, 124, and 125. The network interface 122 is assigned interface number 1, the network interface 123 interface number 2, the network interface 124 interface number 3, and the network interface 125 interface number 4.

The router 101 and the router 111 are connected with a line between the network interface 102 and the network interface 112 and this line is assigned subnet address 192.168.1*. The router 111 and the router 121 are connected with a line between the network interface 113 and the network interface 123 and this line is assigned subnet address 192.168.2*. The router 121 and the router 101 are connected with a line between the network interface 122 and the network interface 105 and this line is assigned subnet address 192.168.3*.

The application server 131 is connected to the network interface 104 of the router 101 and the subnet between them is assigned address 192.168.4*. The application server 132 is connected to the network interface 114 of the router 111 and the subnet between them is assigned address 192.168.5*. The client 141 is connected to the network interface 124 of the router 121 and the subnet between them is assigned address 192.168.6*. The client 142 is connected to the network interface 125 of the router 121 and the subnet between them is assigned address 192.168.7*.

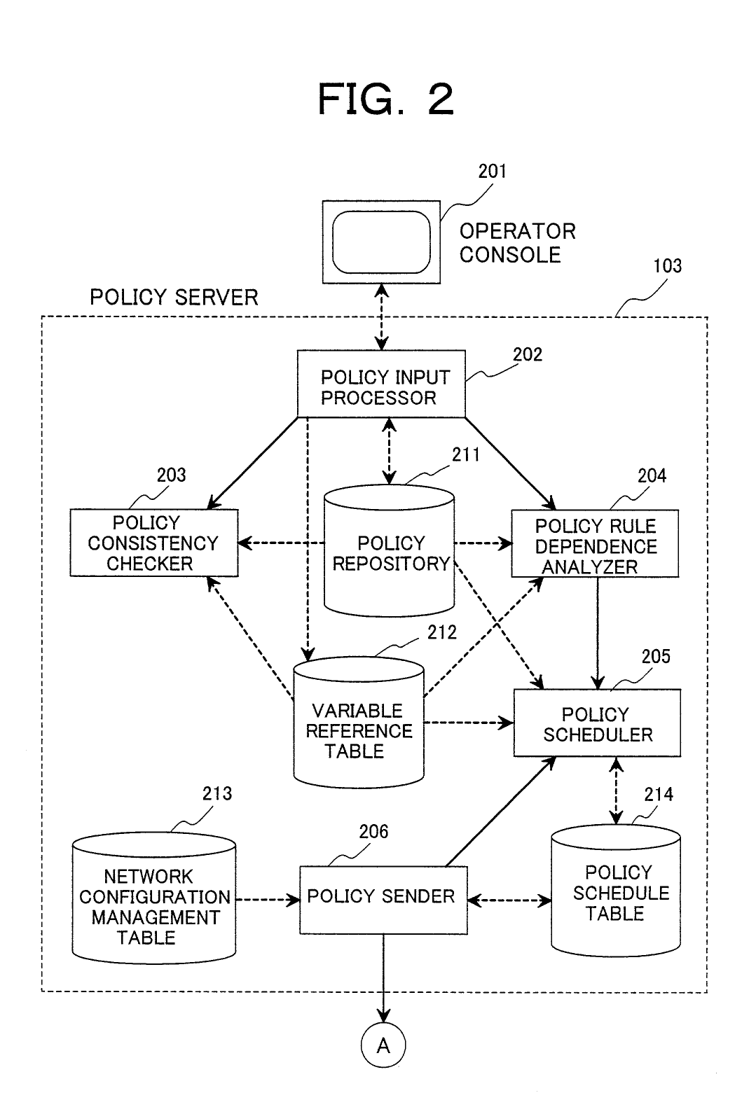

Then, the configuration of the policy server 103 will be described with reference to FIG. 2. The policy server is provided by installing required software on a general-purpose computer such as a personal computer or a workstation. The components of the policy server shown in FIG. 2, a policy input processor 202, a policy consistency checker 203, a policy rule dependence analyzer 204, a policy scheduler 205, and a policy sender 206 are all software units for implementing the server. The remaining components, a policy repository 211, a variable reference table 212, a network configuration management table 213, and a policy schedule table 214 are provided on a hard disk or main storage.

The policy server 103 to which an operator console 201 is connected receives operator inputs or makes outputs to the operator console. The operator uses the operator console 201 to add, remove, or update policy rules and such I/O operation of the operator console is controlled by the policy input processor 202. Input policy rules are stored into the policy repository 211. The policy input processor 202 stores cross-reference relations between variables contained in policy rules into the variable reference table 212. The operator shall specify a valid period of a policy rule when entering the policy rule.

The policy input processor 202 calls the policy rule dependence analyzer 204. By referring to the policy repository 211 and the variable reference table 214, the policy rule dependence analyzer 204 analyzes the relation between the rules entered to be added or removed and the relation between these rules and the existing rules to find dependence of a rule on another rule. This analyzer 204 then delivers at a time the rule identifiers of all interdependent rules to the policy scheduler 205.

The policy consistency checker 203 checks the consistency of the policy rules following the addition, deletion, or update of policy rules. If inconsistency is detected, the inconsistent policy rule or rules are displayed on the operator console 201 via the policy input processor 202.

Using the policy schedule table 214, the policy scheduler 205 adds policy rules to the router at the start of their valid period or removes policy rules from the router at the expiry of their valid period. The policy scheduler 205 is activated by the policy rule dependence analyzer 204 or the policy sender 206. The policy rule dependence analyzer 204 inputs schedule change that follows the addition, deletion, or update of policy rules to the policy scheduler and the policy sender 206 reserves the next schedule of the rule or rules it has sent to the router.

The policy sender 206 sends policy rules as additional ones to a router or removes policy rules from a router, according to the policy schedule table 214. When it does so, the sender uses the network configuration management table 213 to identify the router for which rule data addition/deletion is to be executed.

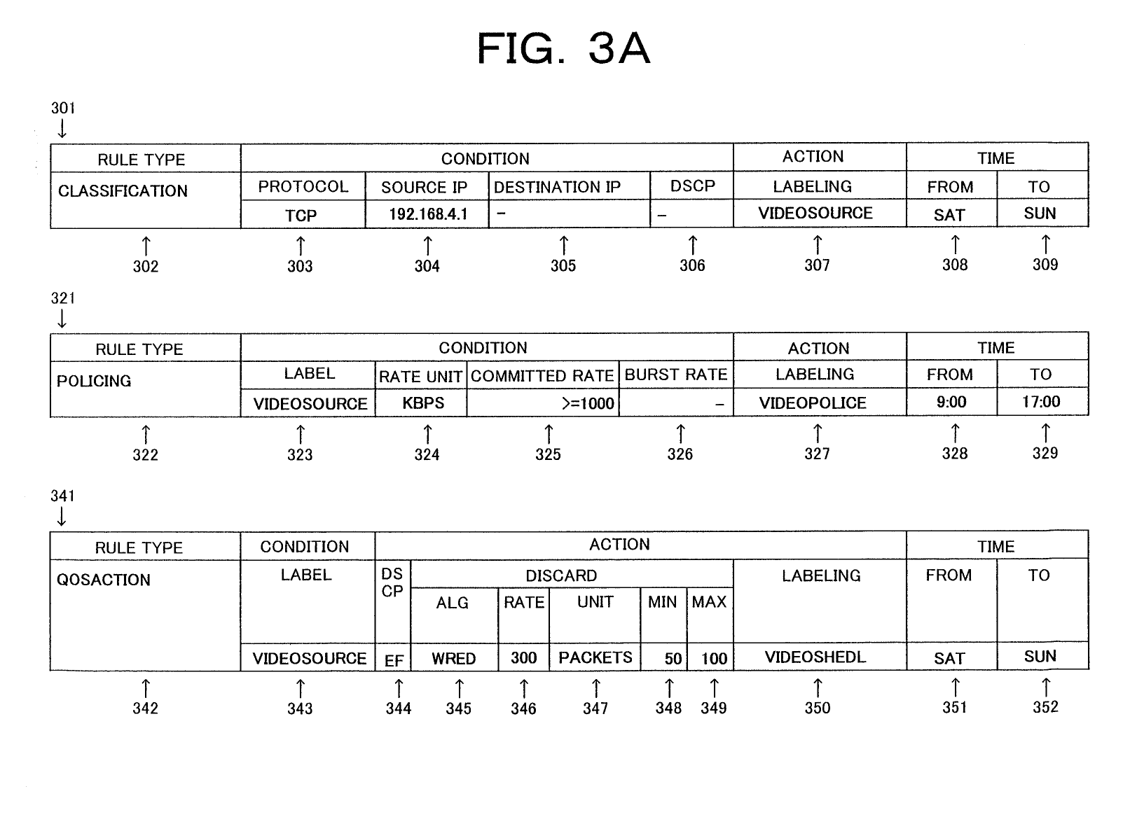

Now, entries that the policy input processor 202 receives from the operator console 201 will be explained with reference to FIG. 3. The operator first selects a type of a policy rule that the operator wants to enter. In the present embodiment, four types of policy rules are available: “Classification”, “Policing”, “QoSAction”, and “Scheduling”. It is assumed that the operator enters all data of rules in order that are specified as samples in templates 301, 321, 341, 361, and 381 for this embodiment.

When the operator selects “classification”, the template 301 is displayed on the operator console 201. In the template 301, source IP address of the flow, label, and time are assumed to have been entered by the operator beforehand. The template 301 includes Classification 302 as the rule type entry. The condition entry comprises protocol 303, source IP address (Source IP) 304 and destination IP address (Destination IP) 305 of flow, and DSCP 306.

As the source and destination IP addresses, not only direct IP addresses but also a range of IP addresses and a range of ports can be specified. The source IP address of 192.168.4.1 is entered in the field 304.

An IP address range is often specified with an address and a mask or a significant bit count of an address. If, for example, an IP address is 192.168.1.0 and a mask is 255.255.255.0 or a significant bit count is 24 bits, an IP address range from 192.168.1.0 to 192.168.1.255 is specified. In this method, however, a specifiable range is more restricted as compared with specifying both upper lower ends of an IP address range. Particularly, if this method is used to specify a plurality of rules, difficulty may arise in setting their conditions exclusive with each other. For example, if an IP address range from 192.168.1.0 to 192.168.1.255 is specified for one rule and the only action for all remaining IP addresses are attempted to be specified, the remaining IP addresses can be specified by specifying two ranges from 0.0.0.0 to 192.168.0.255 and from 192.168.2.0 to 255.255.255.255, provided the ranges can be specified directly. However, if this is attempted to be specified only by using a mask or sufficient bit length, many ranges ORed with each other must be specified. Thus, this is inefficient and probably annoys the user who performs such specification. Such problem is solved if IP address ranges can be specified.

The action entry in the template 301 is to set an integer specified in the field 307 in the Label variable. Here, the integer named VideoSource is entered. The template 301 allows you to set a valid period of the rule by specifying start time 308 and end time 309. Here, Saturday (Sat) is entered as the start time 308 and Sunday (Sun) as the end time 309. This expresses that the rule is valid from 0:00 on Saturday to 24:00 on Sunday (or 0:00 on Monday) every week.

The rule represented by the data entered in the template 301 has the following meaning. Flows that are transmitted from the IP address 192.168.4.1 with the TCP protocol are labeled VideoSource during the period from 0:00 on Saturday to 24:00 on Sunday every week. This labeling functions to determine rules that are to be next activated. This label is, however, different from DSCP and MPLS labels which are actually assigned to packets and is virtually assigned to packets and effective within the router. There are two rules with the condition entry containing the label VideoSource in the template 341 and in the first Condition field in the template 321 as will be described later. Thus, only these rules are next activated.

On the other hand, when the operator selects “policing”, the template 321 is displayed on the operator console 201. In the template 321, the following are specified: condition items, label 323, transfer rate unit 324, inequality sign regarding the maximum average transfer rate (committed rate) 325, and inequality sign regarding the upper limit of a burst rate 326; action, label setting 327; and start time 328 and end time 329 of a valid period of the rule. VideoSource as the label 323, kbps as the transfer rate unit 324, 1000 kbps and over as the maximum transfer rate condition 325, VedioPolice as the label 327 are entered. 9:00 as the start time 328 and 17:00 as the end time are entered, expressing that the rule is valid from 9:00 to 17:00 every day.

The rule represented by the data entered in the template 321 has the following meaning. Flows (virtual flows) with the VideoSource label are assigned the VideoPolice label during the period from 9:00 to 17:00 every day, provided the maximum average transfer rate is equal to or higher than 1000 kbps. This rule does not apply to packets with the VideoSource label that do not meet the above condition and label change is not executed for these packets. Therefore, these packets remain having the VideoSource label.

When the operator selects “QoSAction”, the template 341 is displayed on the operator console 201. In the template 341, the following are specified: a condition, label 343; action items, replacement DSCP 344, packet discard algorithm 345, maximum discard rate 346, threshold unit 347, minimum threshold 348, maximum threshold 349, and label 350; and start time 351 and end time 352 of a valid period of the rule. VideoSource as the label 343, a DSCP of EF, namely 46 as the DSCP 344, Weighted Random Early Discard (WRED) as the packet discard algorithm 345, 300 permil, namely 0.3 as the maximum discard rate 346, packets as the threshold unit 347, 50 (packets) as the minimum threshold 348, 100 (packets) as the maximum threshold 349, VideoSchedl as the label 350, and Saturday as the start time 351 and Sunday as the end time 352 of the valid period of the rule are entered.

The rule represented by the data entered in the template 321 has the following meaning. The EF (Expedited Forwarding) action of DiffServ applies to flows with the VideoSource label during the period from 0:00 on Saturday to 24:00 on Sunday. Packet discard action is performed, according to the WRED and the parameters that are given by the threshold unit 347, minimum threshold 348, and maximum threshold 349. Moreover, the label changes to VideoSchedl, according to the conditions.

The template 361 whose form is the same as that of the template 341 has different contents entered. VideoPolice as the label 363, DropAll as the packet discard algorithm 365, and 9:00 as the start time and 17:00 as the end time of the valid period of the rule are entered. Because all packets are discarded, specifying rules that follow this rule is not necessary and nothing is specified in the label field 370.

The rule represented by the data in the template 361 has the following meaning. Action, discarding all packets applies to flows with the VideoPolice label during the period from 9:00 to 17:00 every day.

When the operator selects “Scheduling”, the template 381 is displayed on the operator console 201. In the template 381, the following are specified: a condition, label 383; action items, rate unit 384, minimum rate 385, maximum rate 386, and parent scheduling label 387; and start time 388 and end time 389 of a valid period of the rule. VideoSchedl as the label 383, kbps as the rate unit 384, 1000 (kbps) as the minimum rate 385, 2000 (kbps) as the maximum rate 386, PrioritySchedl as the parent scheduling label 387, Saturday as the start time 388, and Sunday as the end time 389 are entered.

The rule represented by the data entered in the template 361 has the following meaning. For flows with the label VideoSchedl, the minimum rate of 1000 kbps is assured and the maximum rate of 2000 kbps is applied during the period from 0:00 on Saturday to 24:00 on Sunday every week. If traffic over the maximum rate is found, it is shaped to decrease to 2000 kbps or below. For data input over 2000 kbps, specifically, the excess of data is enqueued and only the data that can be transmitted at 2000 kbps or below is output. If this queuing causes queue overflow, packet discard occurs. As the scheduling method, priority scheduling is used. The reason why the priority scheduling is selected is that a scheduling rule with the PrioritySchedl label, which is not described in FIG. 3, is given in advance.

Then, the meaning of all the above entries as a whole will be explained. For flows originating from the application server 131 with IP address 192.168.4.1, their QoS is assured by applying the EF of DiffServ to them during the period from 0:00 on Saturday to 24:00 on Sunday every week. The WRED discard algorithm is used, the minimum band of 1000 kbps is assured, and the maximum rate is set at 2000 kbps; all packets over this rate are discarded. Priority scheduling (scheduling based on priority) is used as the scheduling method; that is, priority higher than Best Effort traffic is assigned to flows including applicable packets. During the period from 9:00 to 17:00 every day, the foregoing shall apply as long as the transfer rate of 1000 kbps is not exceeded; however, all over-rate packets are discarded.

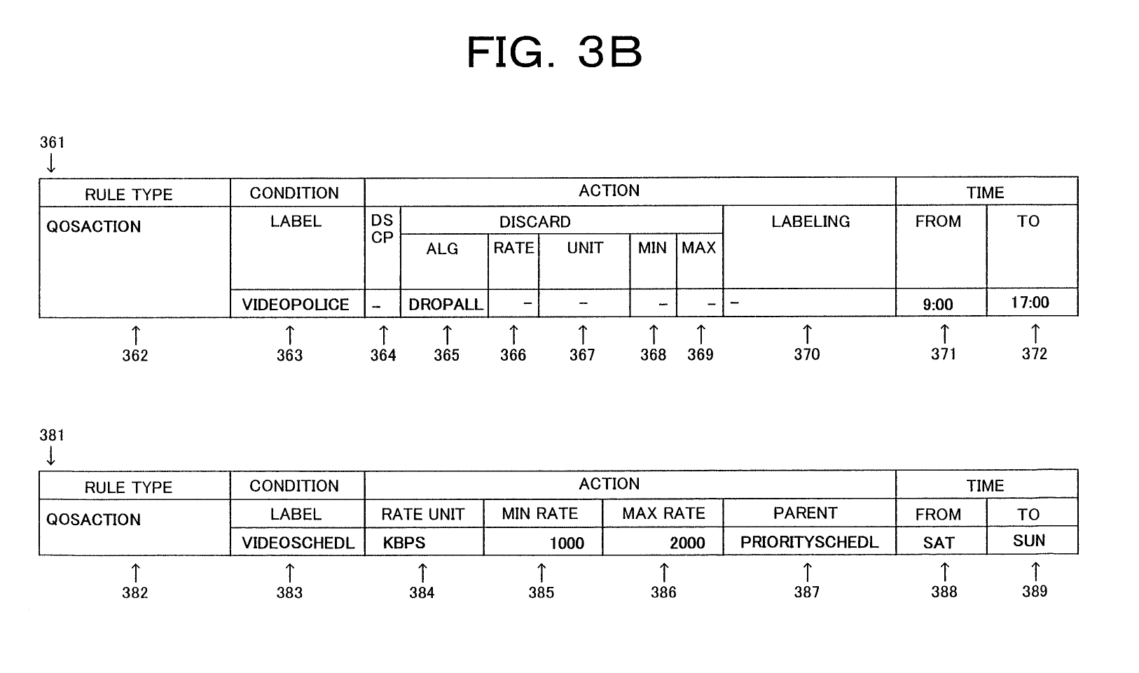

Next, the contents of the policy repository 211 will be explained with regard to FIG. 4A. FIG. 4A illustrate the contents of the policy repository 211 when all entries shown in FIG. 3 have been given to the policy input processor 202 in the mentioned order. A rule table 401 is a fixed-length table that contains all input rules. The table is formed by a field 411 for rule identifier, a field 412 for rule type, a field 413 for the condition part of rule, and a field 414 for the action part of rule. The rule identifier and rule type are fixed-length because they are expressed in integers. However, it may be necessary to describe the condition part and the action part in variable length; in this case, a pointer to a variable-length table that contains the description thereof is used.

On a line 402, a rule with the #1 rule identifier 411 is described and this rule has been entered by using the template 301. The rule type 412 is “classification”. For the condition, the pointer indicates table (A). This table is filled with null data except that protocol 421 is TCP, source IP address of flow is 192.168.4.1 421, and destination IP address of flow is 192.168.4.1 422. Furthermore, the action is to assign a value of 1 to the label variable.

On a line 403, a rule with the #2 rule identifier 411 is described and this rule has been entered by using the template 321. The rule type 412 is “Policing”. For the condition, the pointer indicates table (B) where label 431 is 1, max. Average (Committed) rate 432 is 1000, and burst rate 433 is filled with null data. Furthermore, the action is to assign a value of 2 to the label variable.

On a line 404, a rule with the #3 rule identifier 411 is described and this rule has been entered by using the template 341. The rule type 412 is “QoSAction”. The condition is that the value of the label variable is 1. For the condition, the pointer indicates table (C) where DSCP 441 is 46, discard algorithm 442 is WRED, maximum discard rate 443 is 300 permil, threshold unit 444 is packets, minimum threshold 445 is 50 (packets), maximum threshold 446 is 100 (packets), and label to be assigned 447 is 3.

On a line 405, a rule with the #4 rule identifier 411 is described and this rule has been entered by using the template 361. The rule type 412 is “QoSAction”. The condition is that the value of the label variable is 2. For the action, the pointer indicates table (D) where DSCP 451 is 255 that represents nothing specified, discard algorithm 452 is DropAll that represents discarding all, and the remaining fieldss contain null data.

On a line 406, a rule with the #5 rule identifier 411 is described and this rule has been entered by using the template 381. The rule type is “Scheduling”. The condition is that the label value is 3. For the action, the pointer indicates table (E) where min. assured band (MinRate) 461 is 1000 kbps, max. Average band (MaxRate) 462 is 2000 kbps, and parent scheduling label 464 is PrioritySchedl.

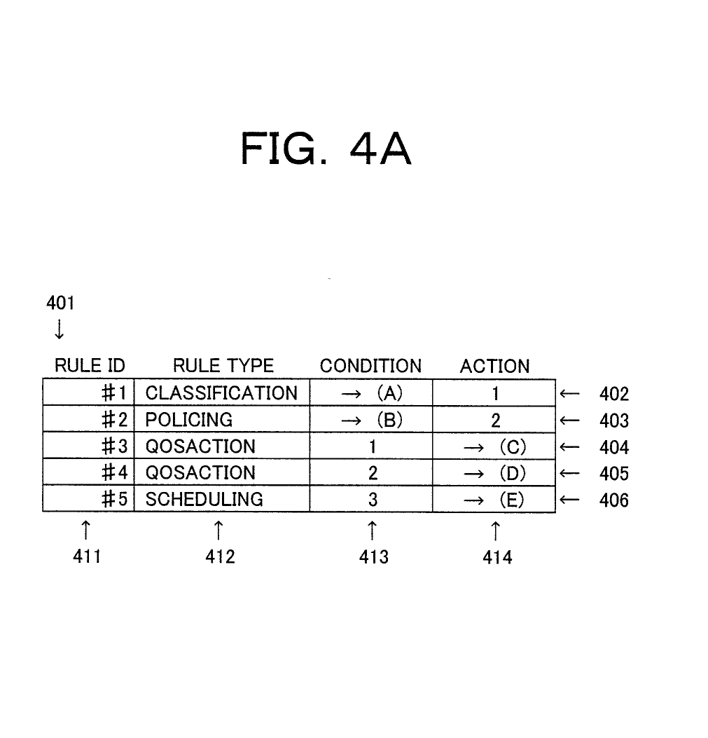

Next, the operation of the policy input processor 202 will be explained with reference to FIG. 5. After the policy input processor 202 starts to operate, it repeats the processing of steps 501 to 532 infinitely. First, in the step 501, the processor displays a rule edit menu, that is, the menu that prompts the operator to select “new rule definition”, “existing rule edit”, or “policy sending” (Deploy) on the operator console 201 and waits for operator input. Then, in the step 502, the processor finds that the operator input is new rule definition, existing rule edit, or policy sending (deployment). If the input is new rule definition, the processor goes to step 511; if the input is existing rule edit, the processor goes to step 521; and if the input is policy sending (deployment), the processor jumps to step 532.

In the step 511, the processor generates one rule identifier that is not used currently. Then, in the step 512, the processor displays a rule type input menu on the operator console 201 and waits for operator input. In the step 514, the processor enters the rule type and the contents of the condition part and the operation part of the new rule with the above rule identifier as a key into the policy repository 211. In the step 514, if the contents of the template 301 have been input to the processor, the data 421 to 427 are generated as the condition part and a value of 1 is assigned to the label variable as the integer corresponding to VideoSource 307 and set in the action part. The rule is then stored into the policy repository 211. The processor goes to step 531.

In the step 521, the processor displays a rule selection menu that allows the operator to select a rule that the operator wants to edit from among the previously entered rules and waits for operator input.

On receiving the operator input, the processor spreads one of the templates shown in FIG. 4 appropriate for the selected rule with the existing contents on the display with “OK” and “Delete” buttons and waits until the operator clicks a button in the step 522. Then, the operator can freely change the contents of the rule in the template. When either button is clicked, the processor deletes all entries of the rule identifier of the rule from the variable reference table 212 in the step 523. In the step 524, the processor then finds which button was clicked: the “OK” button or the “Delete” button. If the “OK” button was clicked, the processor goes to step 525. If the “Delete” button was clicked, the processor goes to step 527.

In the step 525, the processor finds out an existing rule matching the rule identifier key of the edited rule in the policy repository 211 and replaces the existing rule by the edited rule such that the contents of the edited rule are stored into the policy repository 211. In the step 526, the processor then enters the rule identifier of the rule into the variable reference table 212. The processor goes to step 531. In the step 527, the processor finds out an existing rule by using its rule identifier as the key and deletes the existing rule from the policy repository 211. The processor goes to step 531.

In the step 531, the processor calls the policy consistency checker 203. If the checker detects a conflict between the rules, the processor reports the conflict to the operator by displaying it on the operator console 201. The processor returns to the step 501 and waits for operator input.

In the step 532, the processor calls the policy rule dependence analyzer 204 that lists rule identifiers of rules affected by rule addition or deletion. This list and the added rule or rules are sent to the router.

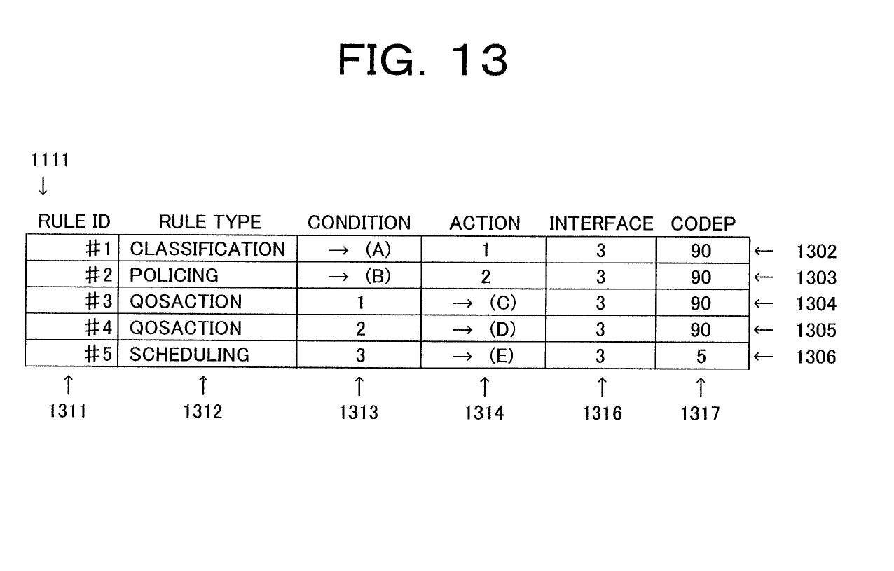

Next, the contents of the variable reference table 212 will be explained with reference to FIG. 14A. The variable reference table 212 comprises a variable definition table 1401 and a variable use table 1421. The variable definition table 1401 contains three elements. A first element 1411 contains a value of #1 as a rule identifier. This indicates that the number 1 variable is defined in the rule with the #1 rule identifier. A second element 1412 contains a value of #2 as a rule identifier. This indicates that the number 2 variable is defined in the rule with the #2 rule identifier. A third element 1413 contains a value of #3 as a rule identifier. This indicates that the number 3 variable is defined in the rule with the #3 rule identifier.

The variable use table 1421 contains three lists. A first list 1431 contains values of #2 (1421) and #3 (1422) as rule identifiers. This indicates that the number 1 variable is used as a condition in the rule with the #2 rule identifier and the rule with the #3 rule identifier. A second list 1432 contains a value of #4 as a rule identifier. This indicates that the number 2 variable is used as a condition in the rule with the #4 rule identifier. A third list 1433 contains a value of #5 as a rule identifier. This indicates that the number 3 variable is used as a condition in the rule with the #5 rule identifier.

The contents of the variable reference table 212 are equivalently represented in a graph form in FIG. 14A. In the graph in FIG. 14A, all nodes represent the rules and a number within a node indicates a rule number. The origin of a directed line indicates the node where the variable value is defined and the terminal point of the line indicates the node where the variable value is used as a condition. A line 1471 indicates that the variable value defined in the rule with the #1 rule identifier is used as a condition in the rule with the #2 rule identifier.

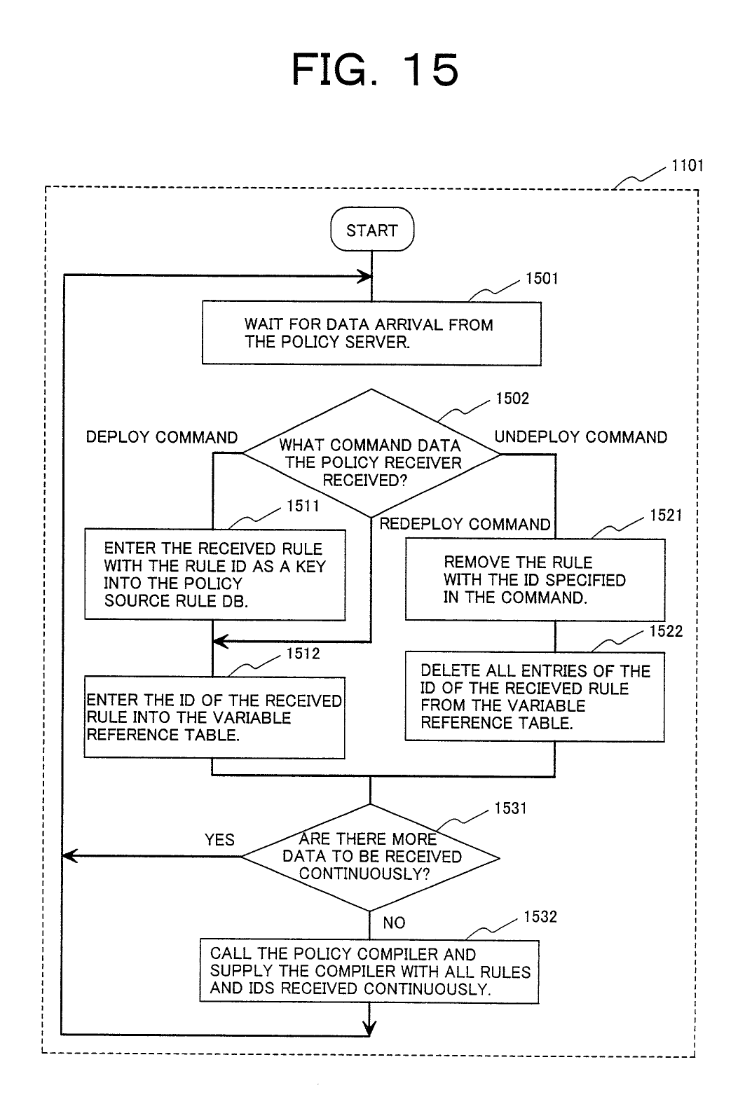

Next, the operation of the policy rule dependence analyzer 204 will be explained with reference to FIG. 16. The policy rule dependence analyzer 204 starts its operation with step 1601 where it obtains transition closure regarding reference relations between variables by using the variable reference table 212. The origin of the transition closure is all rules that are new entries or have been edited before being transmitted to the router. Finding all rules before being transmitted to the router can be implemented by providing flag fields for rules in the rule table 401. When the policy server accepts a new rule entry or an edited rule, the flag for the entry is cleared and at transmission of the rule, the flag is set. All unflagged rules are found to be those before being transmitted. Suppose that any combination or combinations of the rule identifiers #1, #2, #3, #4, and #5 are given, the above step is equivalent to obtaining connections between rules in the graph shown in FIG. 14A. The algorithm for obtaining the transition closure is described in the following references:

A. V. Eiho, J. E. Hopcraft, J. D. Ulman, Algorithm Design and Analysis I, Science Corp. pp. 180-182, 1977

Kiyoshi Ishihata, Algorithm and Data Structure, Iwanami Lecture Software Science 3, Iwanami Shoten Publishers, pp. 275-276, 1989

In the next step 1602, the analyzer sorts the elements of the obtained transition closure. Thereby, the rules can be rearranged such that defined variables always precede those that are used as a condition. In the present embodiment, the rule identifiers are rearranged in order such as #1, #2, #4, #3, #5 or #1, #3, #5, #2, #4. The algorithm for topological sorting is described in the following reference:

Kiyoshi Ishihata, Algorithm and Data Structure, Iwanami Lecture Software Science 3, Iwanami Shoten Publishers, pp. 242-244, 1989

The contents of the variable reference table 212 must be cleared at proper timing and clearing the table immediately following the last step 1604 is well-timed.

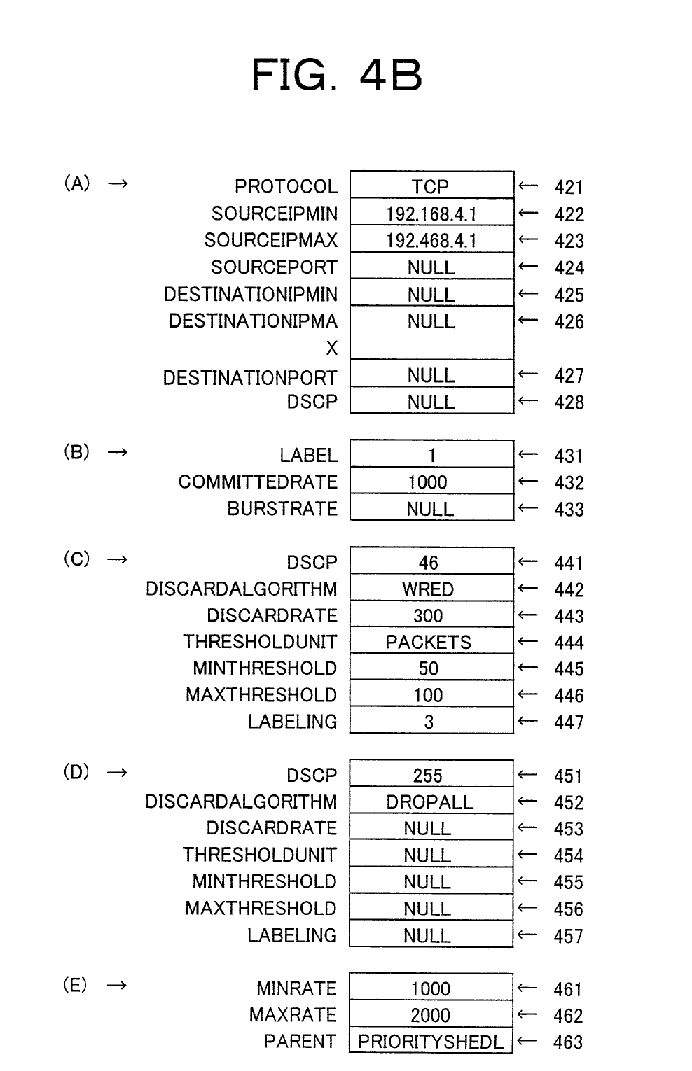

Next, the operation of the policy consistency checker 203 will be explained with reference to FIG. 6. The policy consistency checker 203 starts its operation with step 600 where the processing in steps 601 to 604 is repeated for all rules in parallel with a rule that has been specified. Finding all rules in parallel with the specified rule is performed in the following way. If the specified rule is a classification rule, find all classification rules in the rule table 401. If the specified rule is a policing rule, the checker can be found by selecting all policing rules from among all rules that use the same variable as given in the rule by using the variable reference table 212. As regards QoS action and scheduling rules, no parallel rules exist.

In the step 601, the checker finds whether a rule to be processed still remains. If such rule still remains, the checker goes to step 603; if not, the checker goes to step 602. In the step 602, the checker reports that the policy is consistent to the program in which it was called. Then, the processing of the policy consistency checker 203 terminates. In the step 603, the checker judges whether the condition of the above rule and the condition of the newly inputted rule are exclusive with each other. If the conditions of the rules are exclusive with each other, the checker returns to the step 601 and continues its processing for rules. If the conditions of the rules are not exclusive with each other, the checker goes to step 604. In the step 604, the checker reports that the policy is inconsistent to the processor that called it. Then, the processing of the policy consistency checker 203 terminates.

When policy inconsistency is detected, the policy input processor 202 which called the above checker displays a message indicating inconsistency on the operator console 201. In the present embodiment, the policy consistency checker 203 checks to see whether the conditions of a plurality of rules are exclusive with each other and non-exclusive conditions of rules, that is, inconsistency is reported to the operator for revision. The reason for that is that non-exclusive conditions of rules result in the following. First, such inconsistency may change the meaning of rules when the rules are rearranged in the policy server 103 and the router 101, causing unintended operation for the operator. Second, the rules that are not exclusive with each other are of some interdependence between them and therefore cannot be treated as independent rules. Consequently, this increases the data quantity to be transferred from the policy server 103 to the router 101 and increases the load on a policy rule compiler 1103.

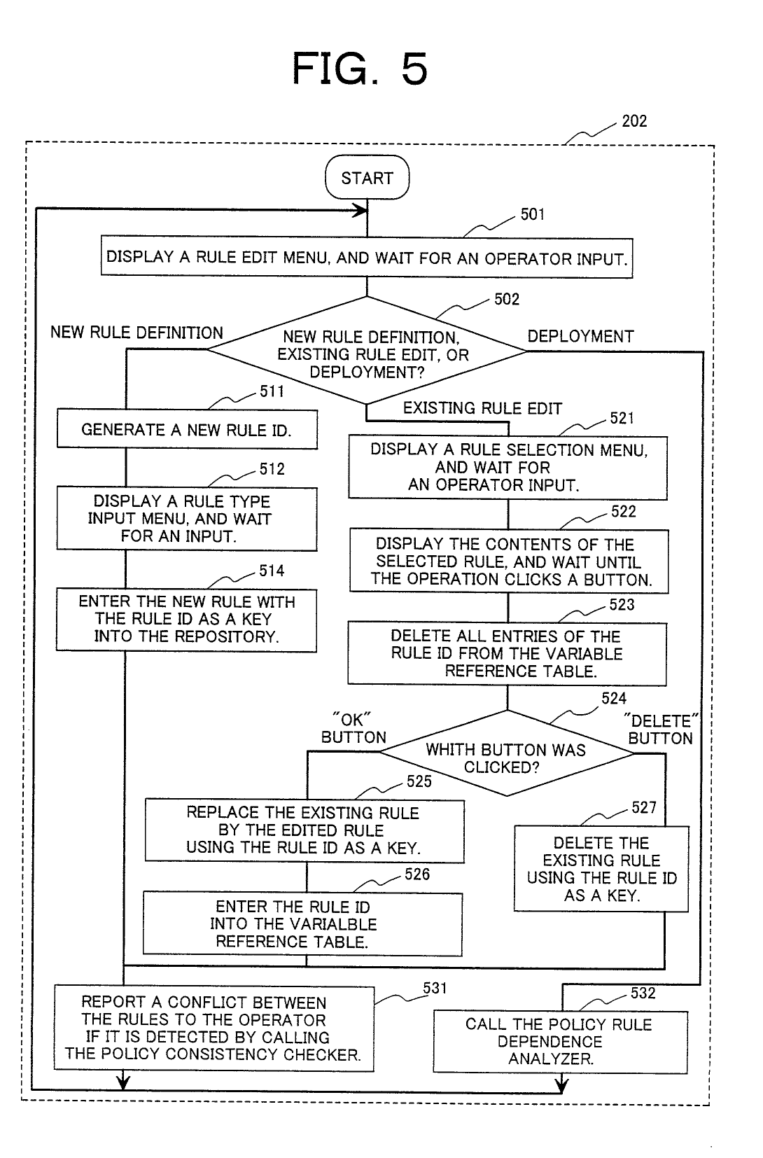

Now, the contents of the policy schedule table 214 will be explained with reference to FIG. 7.

FIG. 7 illustrates the contents of the policy schedule table 214 assumed to be set immediately after all rules are entered as specified in the templates shown in FIG. 3 at 18:00 on Nov. 26, 1999. The table is formed by rule identifier field 721, a scheduled event field 722, a next time field 723 at which the event is to occur, and a time field 724 that is given in the rule. The entry on a first line 702 has the following meaning. The rule identifier is #1. The event is “Deploy” that indicates that the specified rule is transmitted to the router as an additional one. As the next time, 0:00 on Nov. 27, 1999 is specified. The given time is Saturday (Sat). The entry on a sixth line 707 has the following meaning. The rule identifier is #2. The event is “Undeploy” that indicates that the specified rule is removed from the router. As the next time, 17:00 on Nov. 27, 1999 is specified. The given time is 17:00 (every day).

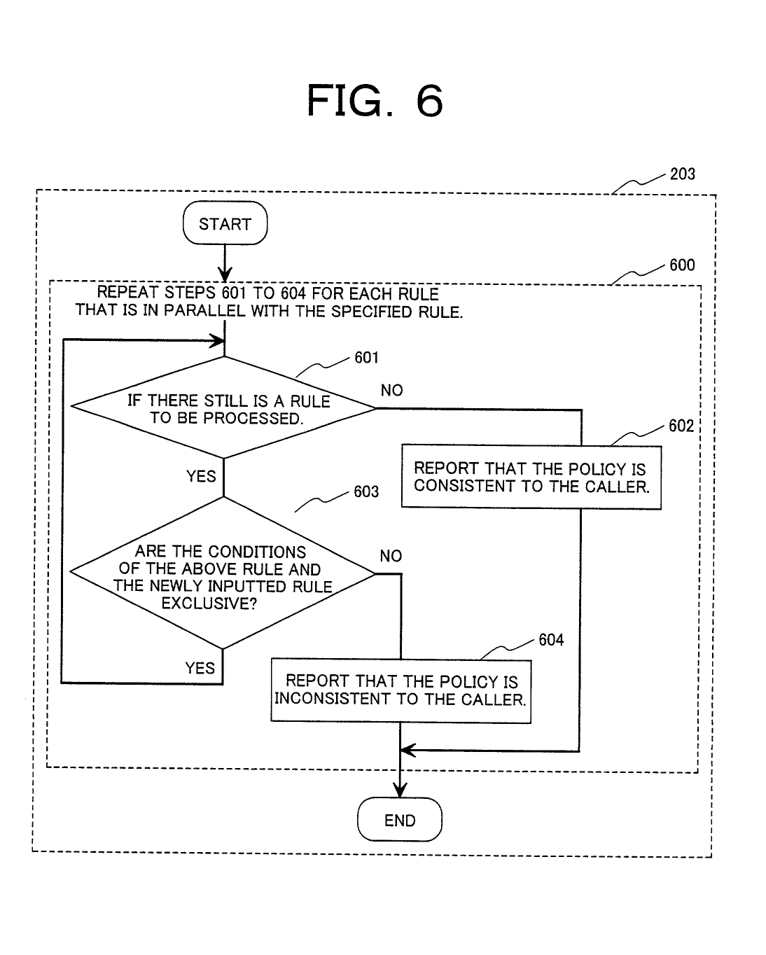

Next, the operation of the policy scheduler 205 will be explained with reference to FIG. 8. The policy scheduler 205 starts its operation with step 801 where it waits for an input from the policy dependence analyzer 204 or the policy sender 206. When receiving an input, the scheduler judges which of the above two sent the input in the step 802. On receiving the input from the policy dependence analyzer 204, the scheduler goes to step 803. On receiving the input from the policy sender 206, the scheduler goes to step 804.

In the step 803, the scheduler generates “Deploy” event data and “Undeploy” event data from the inputted rule as items to be entered in the schedule table and inserts them into the policy schedule table 214. For example, for the rule with the #1 rule identifier, which has been registered on the line 402 in the policy repository 211, the scheduler processes it as follows. From the rule data, the scheduler generates “Deploy” and related data and enters them on a line 702 of the schedule table and generates “Undeploy” and related data and enters them on a line 709 of the schedule table. The generated data is inserted into the policy scheduler table 214 in position so that the time values contained in the next time field 723 will be arranged in the ascending order.

The entry “Sat” (Saturday) in the given Time field 724 on the line 702 is copied from the start time 308 of the template 301 and the entry “Sun” (Sunday) in the given Time field 724 on the line 709 is copied from the end time 309 of the template 301. The entry 0:00 on Nov. 27, 1999 in the Next time field 723 on the line 702 is the nearest future time from the current time that is assumed to be 18:00 on Nov. 26, 1999, meeting the condition of the-beginning of “every Saturday” specified in the given Time field 724. The entry 0:00 on Nov. 29, 1999 in the Next time field 723 on the line 709 is the nearest future time from the current time, meeting the condition of the end of “every Sunday” specified in the given Time field 724.

In the step 804, the scheduler generates next schedule data items for the rule sent by the sender and inserts them into the policy schedule table 214. It generates data items that are the same entries as those of the sent rule in the Rule ID field 721, the Event field 722, and the given Time field 724 and next time for which the rule is scheduled to be sent after the time specified for the sent rule in the Next time field 723. When the sender sends, for example, the rule whose schedule data was entered on the line 702, the scheduler generates data items of #1 in the Rule ID field 721, Deploy in the Event field 722, 1999-12-4 0:00 representing 0:00 on Dec. 4, 1999 in the Next time field 723, and Sat in the given Time field 724, and appends them to the last line of the policy schedule table 214.

After completing the steps 803 and 804, the scheduler returns to the step 801 and waits for further input.

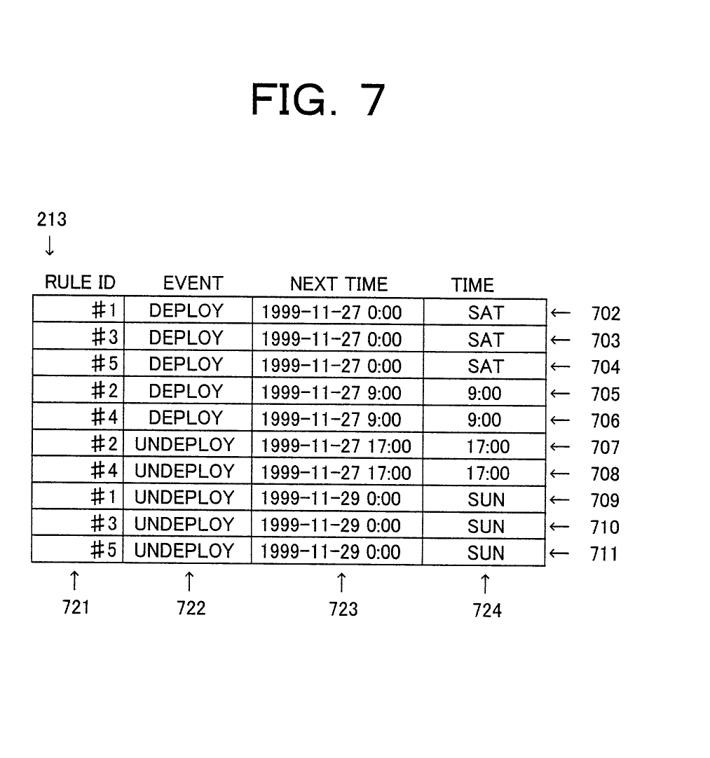

Now, the contents of the network configuration management table 213 will be explained with reference to FIG. 9.

The network configuration management table 213 is formed by three fields: a target IP address field 911, a router IP field 912, and a router interface field 913. The network configuration management table 213 contains four lines of registered entries for the present embodiment. On a first line 902, the table holds 192.168.4.* in the target IP address field 911, 192.168.1.2 in the router IP field 912, and 3 in the router interface field 913. The contents of the first line 902 indicate that the interface with interface number 3 of the router with IP address 192.168.1.2 is connected to the subnet 192.168.4.*.

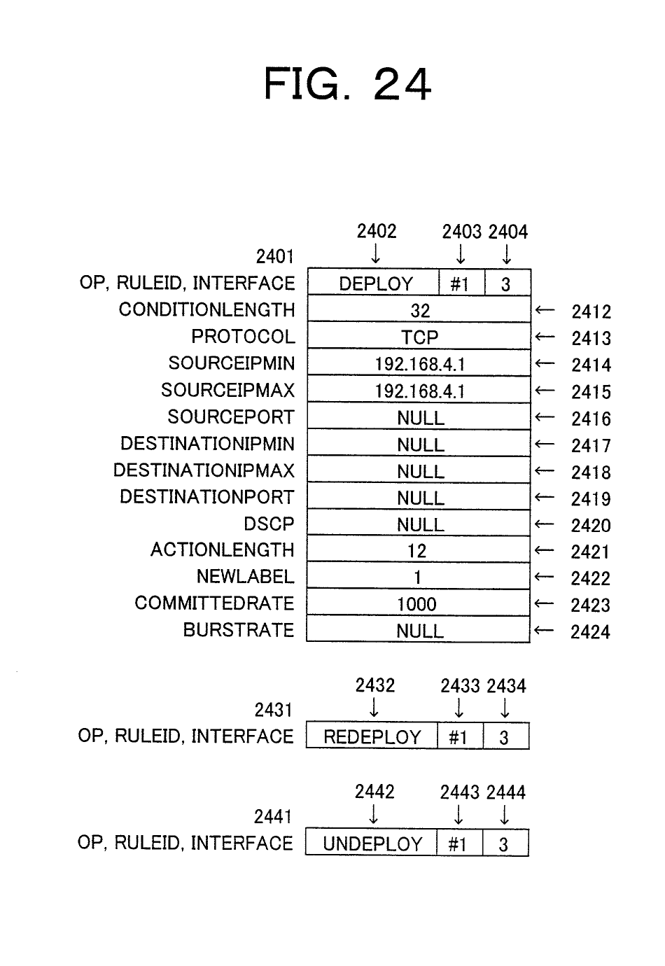

Next, the contents of protocol data that is sent from the policy server 103 to the router 101 will be explained with reference to FIG. 24. For the protocol applied to the present embodiment, three types of command data are used. The first one is a Deploy command 2401, the second one is a Redeploy command 2431, and the third one is an Undeploy command 2441.

The Deploy command 2401 contains information on the rule identifier of one rule, the contents of the rule, and the network interface on which the rule takes effect. The Deploy command 2401 requires that the rule be stored into the receiver router and executed to take effect on the specified network interface. A router Op code 2402 contains “Deploy” indicating that this data is a Deploy command. The value in a rule identifier field 2403 indicates the rule identifier of the rule included in the Deploy command. The value in an interface field 2404 indicates the network interface number on which the Deploy command is to act.

Length of condition part 2412 indicates the length of the condition part of the rule included in the Deploy command in units of bytes. This field of the Deploy command 2401 includes a value of 32 indicating that the condition part from a protocol field 2413 to a DSCP field 2420 is 32 bytes long. The condition part comprises a protocol field 2413 containing “TCP”, a field for the lower end of source IP address of flow 2414 containing “192.168.4.1”, a field for the upper end of source IP address of flow containing “192.168.4.1”, a field for source port of flow 2416 containing “null”, a field for the lower end of destination address of flow 2417 containing “null”, a field for the upper end of destination address of flow 2418 containing “null”, a field for destination port of flow 2419 containing “null”, and a DSCP field 2420 containing “null”.

Length of action part 2421 indicates the length of the action part of the rule included in the Deploy command in units of bytes. This field of the Deploy command 2401 contains a value of 12 indicating that the action part from a label field 2422 to a burst rate filed 2424 is 12 bytes long. The action part comprises a level field 2422 containing “1”, a maximum rate field 2423 containing “1000” (kbps),”, and a burst rate field 2424 containing “null”.

The Redeploy command 2431 contains information on the rule identifier of one rule and the network interface on which the rule takes effect. The Redeploy command declares that the rule that must has been stored in the receiver router shall be executed to take effect on the specified network interface together with other commands that are sent concurrently. An Op code 2432 contains “Redeploy” indicating that this data is a Redeploy command. The value in a rule identifier field 2433 indicates the rule identifier of the rule included in the Redeploy command. The value in an interface field 2434 indicates the network interface number on which the Redeploy command is to act.

The Undeploy command 2441 contains information on the rule identifier of one rule and the network interface on which the rule takes effect. The Undeploy command 2441 requires that the rule shall not take effect on the specified network interface and declares that the rule may be removed from the router if the rule becomes ineffective for any network interface. Determining whether the rule is actually removed from the router is left to the judgment of the receiver router. An Op code 2442 contains “Undeploy” indicating that this data is an Undeploy command. The value in a rule identifier field 2443 indicates the rule identifier of the rule included in the Undeploy command. The value in an interface field 2444 indicates the network interface number on which the Undeploy command is to act.

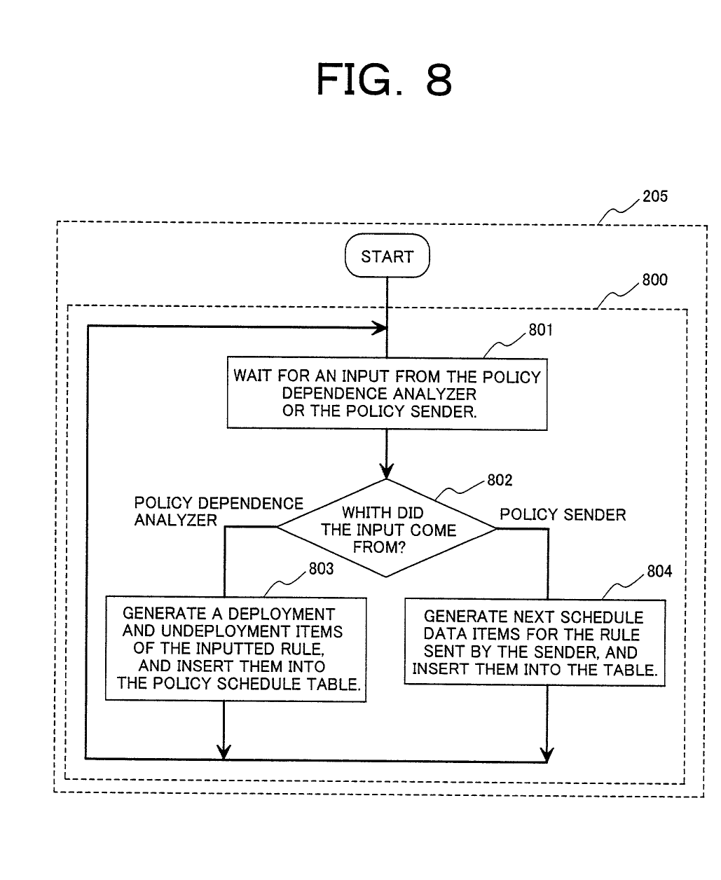

Then, the operation of the policy sender 206 will be explained with reference to FIG. 10. The policy sender 206 starts its operation with step 1001 where it hops the first scheduled item in the policy schedule table 214. Specifically, the sender retrieves the first item and deletes the line of the item from the policy schedule table 214. In the next step 1002, the sender refers to the network configuration management table 213 and finds the router and its interface number corresponding to the scheduled item retrieved. According to the hopped item on the line 702 of the schedule table, the rule identifier of #1 is found. By searching the policy repository 211 with the key of the #1 rule identifier, the line 402 is found. In the table (A) that is pointed from the Condition field 413 on the line 402, the source IP address 192.168.4.1 is found. By using this address, the network configuration management table 213 is searched. Because the subnet 192.168.4.* includes the IP address 192.168.4.1, a router with IP address 192.168.1.2 and interface number 3 are found.

In the next step 1003, the sender waits until the time specified in the above scheduled item comes. For the item on the line 702 of the schedule table, the step 1004 and subsequent steps are executed at 0:00 on Nov. 27, 1999. In the step 1004, the sender finds what event specified in the scheduled item. If the event is Deploy, the sender goes to step 1011. If the event is Undepoy, the sender goes to step 1021.

In the step 1011, the sender judges whether the rule specified in the scheduled item has already been sent to the above router and stored in the router. Here, the sender judges, according to the information held on the policy server 103, not querying the router. If the flag management method is used to judge whether rules have been transmitted as described for FIG. 16, the sender can judges in the step 1011 only by referring to the flags. As the result of judgment, if the rule exists on the router, the sender goes to step 1012; if not, the sender goes to step 1016.

In the step 1012, the sender sends a redeploy command for the above rule to the router. In this redeploy command, the rule identifier of the rule and the appropriate interface number shall be specified. Then, the sender goes to step 1031.

In the step 1016, the sender sends a deploy command for the rule to the router. In this deploy command, the rule identifier of the rule, the contents of the rule, and the appropriate interface number shall be specified. Because the rule identifier #1 is specified on the first line 702 of the schedule table, the line 402 of the policy repository 211 and the table (A) pointed from the line 402 are retrieved and the contents thereof are sent. The type of the command is a deploy command that is specified in the Event field 722 on the line 702. Then, the sender goes to the step 1031.

The sender executes the step 1016 for both cases where the rule is added and where the rule is updated. The sender may send the deploy command for sending the rule to the router as an additional one or for substituting the rule included in the command for the previously defined rule with the same rule identifier.

In the step 1021, the sender sends an undeploy command for the rule to the router. In this undeploy command, the rule identifier of the rule and the appropriate interface number shall be specified. Finally, the sender activates the policy scheduler 205 in the step 1031.

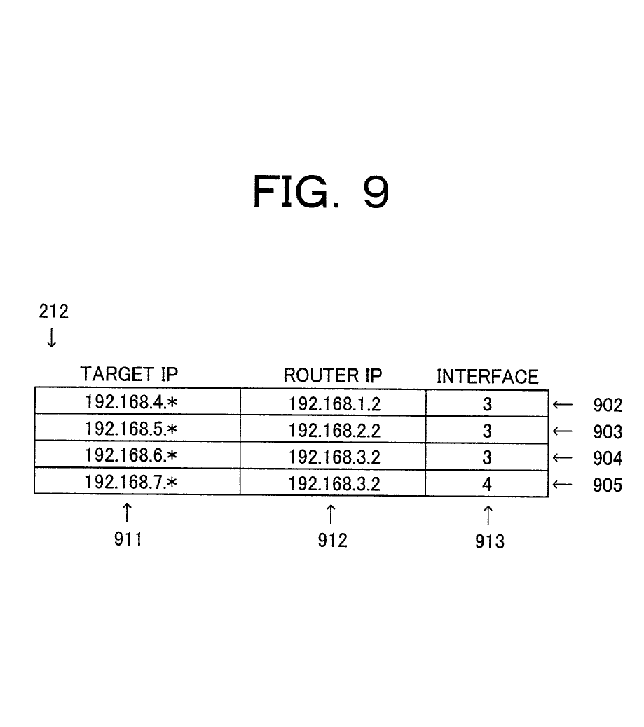

Now, the configuration of the router 101 will be explained with reference to FIG. 11. The configuration of the router 111 and the router 121 is also as shown in FIG. 11. A policy receiver 1101, a policy rule dependence analyzer 1102, and a policy rule compiler 1103, which will be described later, are software units for implementing the router. A crossbar switch 1120, a network interface 1122, and a network interface 1123, are hardware units for implementing the router. A traffic control 1121 and a routing control 1124 may be either software or hardware units for implementing the router. A variable reference table 1112 and a policy source rule DB 1111 are provided on main storage or other semiconductor storage. A policy rule table 1113 and a queue configuration table 1114 are provided on registers or main storage.

From the policy server 103, the policy receiver 1101 receives policy rules and stores them into the policy source rule DB 1111 and receives variable reference table data and stores this data into the variable reference table 1112. Furthermore, the policy receiver 1101 delivers the received rule identifier list to the policy rule compiler 1103. The policy rule compiler 1103 converts at a time the rules contained in the rule identifier list it received and stores the converted rules into the policy rule table 113 and the queue configuration table 1114.

The traffic control 1121 controls traffic incoming and outgoing through the network interface 1122 and the network interface 1123 by using the policy rule table 1113 and the queue configuration table 1114. The crossbar switch 1120 executes data transfer between the network interfaces under the control of the routing control 1124.

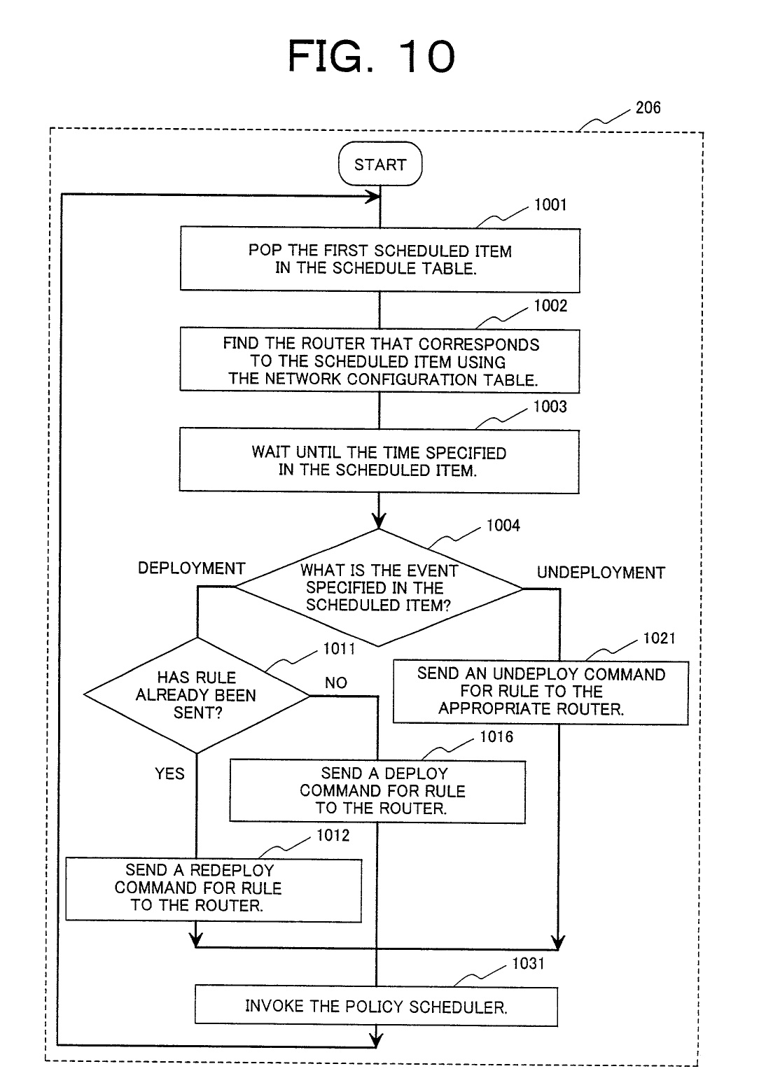

Then, the configuration of the network interface 1122 will be explained with reference to FIG. 12. The configuration of the network interface 1123 is also as shown in FIG. 12. Packets input to the network interface 1122 are first classified as those belonging to a flow in a flow classifier 1201. A classification rule controls the flow classifier 1201. Then, a flow meter judges whether the flow satisfies the specified traffic condition. According to the result of this judgment, a scheduler 1203 selects an output queue where the packets are to be placed from among the output queues provided therein, shapes the flow if necessary, and takes action such as packet discard. The output from the queue is sent to the crossbar switch 1120.

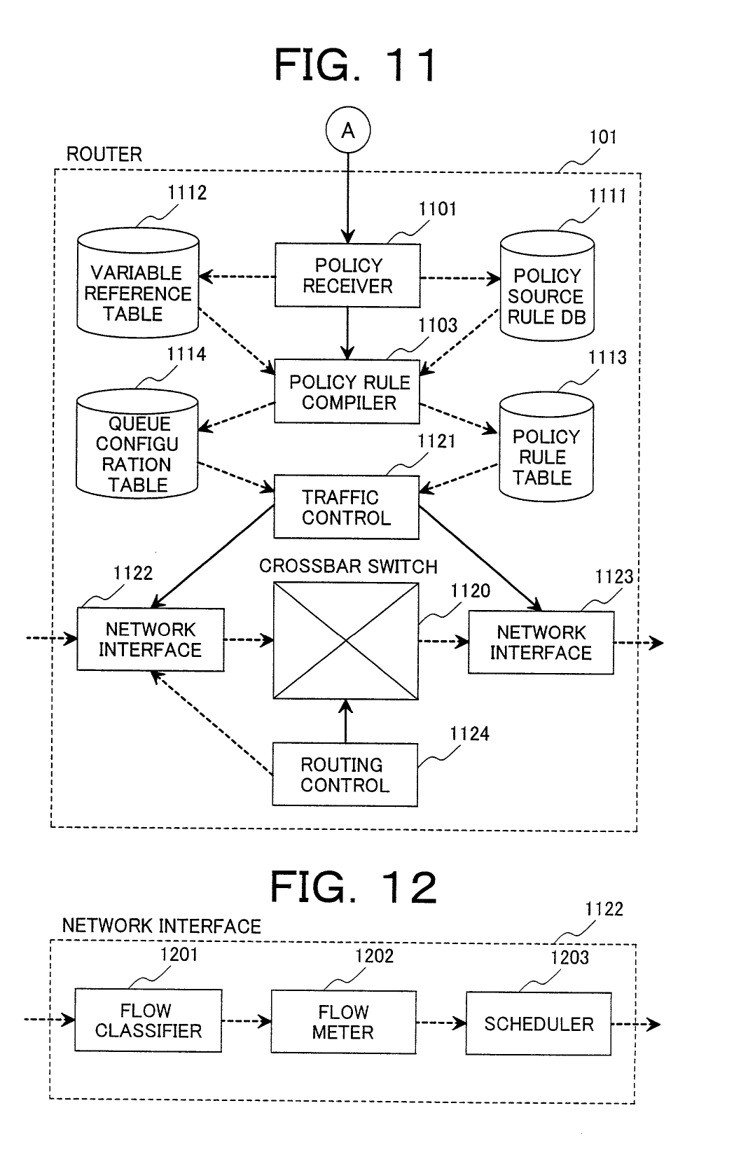

Next, the contents of the policy source rule DB 1111 will be explained with reference to FIG. 13. FIG. 13 illustrates the contents of the policy source rule DB 1111 on the assumption that all template entries shown in FIG. 3 have been supplied to the policy input processor in the specified order. The contents of a Rule ID field 1311, a Rule type field 1312, a Condition field 1313, and an Action field 1314 of the policy source rule DB 1111 correspond to the contents of the Rule ID field 411, Rule type field 412, Condition field 413, and Action field 414 of the policy repository 211. The value in an Interface field 1316 indicates the network interface number on which the rule is to take effect. The value in a Codep field 1317 indicates the address where the converted rule has been stored in the policy rule table 1113.

A line 1302 contains a rule with the #1 rule identifier 1311 which has been entered by the template 301. Its interface field 1316 contains 3 and its codep field contains 90. A line 1303 contains a rule with the #2 rule identifier 1311 which has been entered by the template 321. Its interface field 1316 contains 3 and its codep field 1317 contains 90. This Codep field value equals to that on the line 1302 and this indicates that the rule on the line 1302 and the rule on the line 1303 are merged into one rule when being converted into form that they can be executed. The rules on line 1304 and line 1305 are also merged into the same rule when being converted into form that they can be executed.

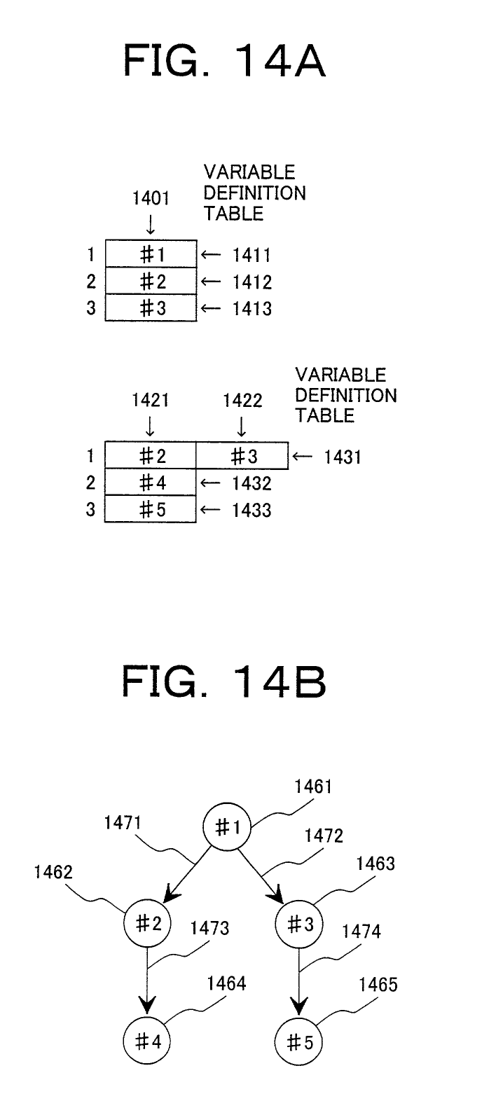

Next, the operation of the policy receiver 1101 will be explained with reference to FIG. 15. The policy receiver 1101 starts its operation with step 1501 where it waits for arrival of send data from the policy server 101. When receiving data, the receiver finds what command data it received in the step 1502. If received a Deploy command, the receiver goes to step 1511. If received an Undeploy command, the receiver goes to step 1521. If received a Redeploy command, the receiver goes to step 1512.

In the step 1511, the receiver enters the rule specified in the Deploy command with the rule identifier as a key into the policy source rule DB. Then, the receiver goes to step 1512.

In the step 1512, the receiver enters the rule identifier of the received rule into the variable reference table 1112. Then, the receiver goes to step 1531.

In the step 1521, the receiver removes the rule with the rule identifier specified in the Undeploy command. In the next step 1522, the receiver deletes all entries of the rule identifier of the received rule from the variable reference table 1112. Then, the receiver goes to step 1531.

In the step 1531, the receiver judges whether there are more data to be received continuously. If there are more data, the receiver returns to the step 1501 to receive and process next data. Unless there are more data, the receiver goes to step 1532. Specifically, the receiver finds whether next data will arrive within a given time period in the step 1531, and executes required data processing if data arrival occurs or enters the next processing unless data arrival occurs. In the step 1532, the receiver calls the policy compiler 1103 and supplies the compiler with all rules and identifiers received continuously. Then, the receiver returns to the step 1501 and becomes ready to receive and process next data.

The receiver knows the end of a block of data by judging whether next data comes within a given time in the step 1531. In order to know the end of a block of data more reliably and rapidly, it is advisable to insert a command that indicates of the end of data in the data sent from the policy server 103. That is, create a Commit command and issue the Commit command at timing when the policy rule dependence analyzer 204 is called. When the router 101 receives the commit command, the receiver executes the step 1532.

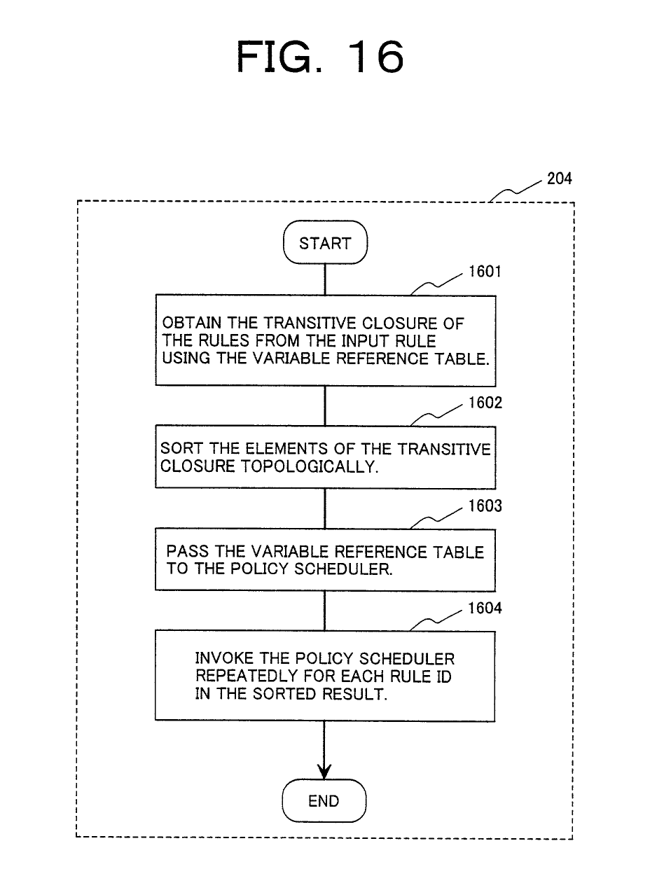

Then, the contents of the policy rule table 1113 will be explained with reference to FIG. 17. The policy rule table 113 contains rules put together per network interface. Of a start instruction address table 1701, its first element points to a list of rules for a network interface of interface number 1 and its second element points to a list of rules for a network interface of interface number 2. In FIG. 17, however, these lists are empty. The third element of the start instruction address table 1701 points to a list of rules for a network interface of interface number 3 and the start address of this list is 90 (1704).

In the area at address 90, a rule 1708 is stored. The rule 1708 is one into which the contents of all rules in FIG. 3 are merged. That is, a plurality of rules in FIG. 3 is merged into one rule 1708 in form that they can be executed. However, part of the information contained in the rules in FIG. 3 is stored into the queue configuration table 1114 but does not exist in the rule 1708.

In the rule 1708, a string of 192.168.4.1 is specified in the field of lower end of source IP address of flow 1721 and the same is also specified in the field of upper end of source IP address of flow 1722. Thus, the rule 1708 is effective only for packets originating from the IP address 192.168.4.1. A value of 0 is specified in the field of source port 1723, indicating that no port number is specified. A string of 0.0.0.0 is specified in the field of lower end of destination IP address of flow 1724 and a string of 255.2355.255.255 is specified in the field of upper end thereof 1725. This indicates that the destination IP address is arbitrary. In the field of destination port 1726, a value of 0 is specified, indicating the destination port number is arbitrary.

In the DSCP field 1727, a value of DSCP shall be specified if DSCP is used for classification. Thus, a value in a range of 0 to 63 may be specified. Because DSCP is not used for classification in the case of the rule 1708, however, a value of 255 is specified in the DSCP field 1727. In the max. average (Committed) rate field 1728, a value greater than 0 shall be specified if the upper limit of bandwidth is specified, but a value of 0 shall be specified if not. In the burst rate field 1729, a value greater than 0 shall be specified if the temporary upper limit of bandwidth is specified, but a value of 0 shall be specified if not. For the rule 1708, a value of 0 is specified in this field.

In the queue number field 1730, a queue number is specified. The queue number shall be between 0 and the number of queues less one. In the new DSCP field 1731, a value between 0 and 63 shall be specified if DSCP replacement takes place when the rule is executed and a value of 255 shall be specified if not. For the rule 1708, the DSCP of EF, namely 46 is specified in this field. In the Penalty action field 1732, action shall be specified that is to be taken when the traffic of flows specified in the rule 1708 exceeds bandwidth corresponding to the max. average rate (Committed) 1728 and/or burst rate 1729 if specified. Unless the max. average rate (Committed) 1728 and/or burst rate 1729 is specified, the content of the Penalty action 1732 field is ignored. As the Penalty action 1732, action such as DSCP replacement and packet discard may be specified. For the rule 1708, drop is specified in this field, indicating that over-bandwidth packets are discarded.

As defined by the rule table contents described above, the rule 1708 that takes effect on the network interface 104 of the router 101 has the following meaning. For flows originating from the address 192.168.4.1, their IP packets are marked with the DSCP of EF, namely 46 and placed in the queue of queue number 5 as long as the average rate does not exceed 1000 kbps. If the average rate exceeds 1000 kbps, the over-rate packets are discarded. The rule 1708 which has the above meaning, when it combines with other regulative items set for the queue 1811, which will be described later, eventually represents the same meaning as defined by all rules represented by the data entered in the templates in FIG. 3. The rule 1708 applies to the flows from the application server 131 through the router 101 to the client 141 and the client 142.

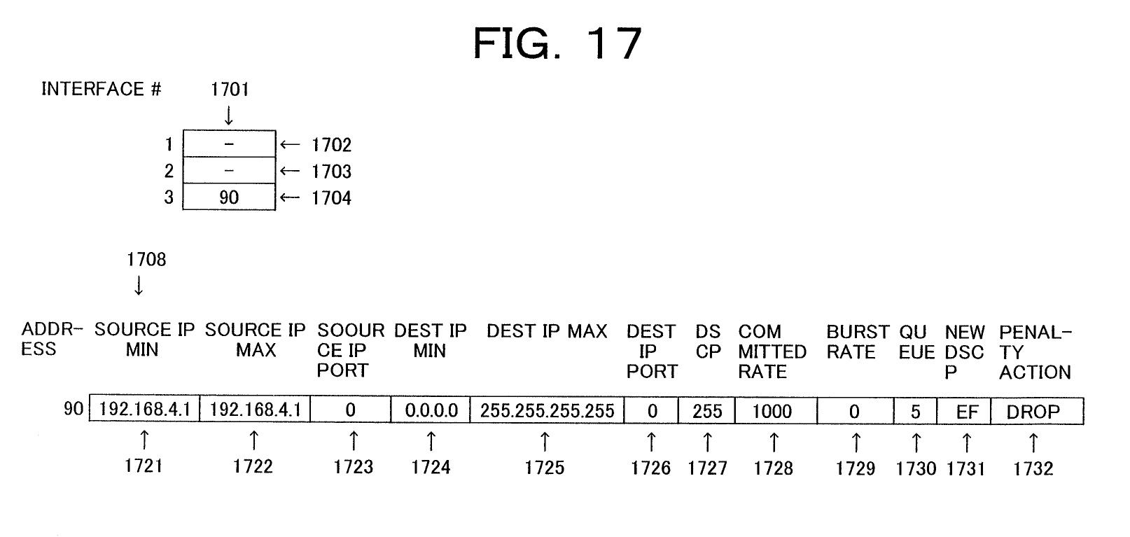

Next, the contents of the queue configuration table 1114 will be explained with reference to FIG. 18. The queue configuration table 1114 contains queues put together per network interface. The first line of the queue configuration table 1114 points to the queues set for interface number 1 and the second line thereof points to the queues set for interface number 2. In FIG. 18, these lines are however empty. The third line of this table 1114 indicates to the queues set for interface number 3 and contains “50” as the start address of the queues and “PrioritySchedl”, that is, priority scheduling as the scheduling algorithm (1805).

In the area at address 50, the interface-specific configuration table 1808 is stored. The router 101 has eight queues numbered 0 to 7 and the interface-specific configuration table 1808 consists of eight lines indexed 0 to 7. The interface-specific configuration table 1808 is formed by the following fields. The value in the minimum rate field 1821 indicates minimum assured bandwidth. The value in the maximum rate field 1822 indicates maximum bandwidth, input in excess of which is shaped. The setting in the field of discard algorithm 1824 specifies a discard algorithm that applies when packets are placed in the queue. If the queue is empty, the received packets are not discarded; if the queue is filled with packets, further packets are discarded. If some space remains in the queue, the received packets are queued or discarded, according to the discard algorithm set in the field 1824. As the parameters of the discard algorithm, a maximum discard rate 1825, a minimum threshold 1826, and a maximum threshold shall be specified.

Regulative items for the queue of queue number 5 are set on a line 1811. On this line, “1000” is specified in the minimum rate field 1821, “2000” in the maximum rate field 1822, “WRED” in the discard algorithm field 1824, “300” in the maximum discard rate field 1825, “50” in the minimum threshold field 1826, and “100” in the maximum threshold field 1827. To the queue of queue number 5, thus, the following scheduling applies. The priority scheduling applied to this queue as the scheduling algorithm indicates that the priority of this queue is higher than the queues numbered 0 to 4 and lower than the queues numbered 6 and 7. 1000 kbps is assured as the minimum bandwidth, but input shaping is executed if the data rate exceeds the maximum bandwidth 2000 kbps. WRED applies as the discard algorithm with the parameters of the maximum discard rate 1825 of 300, the minimum threshold 1826 of 50 and the maximum threshold 1827 of 100.

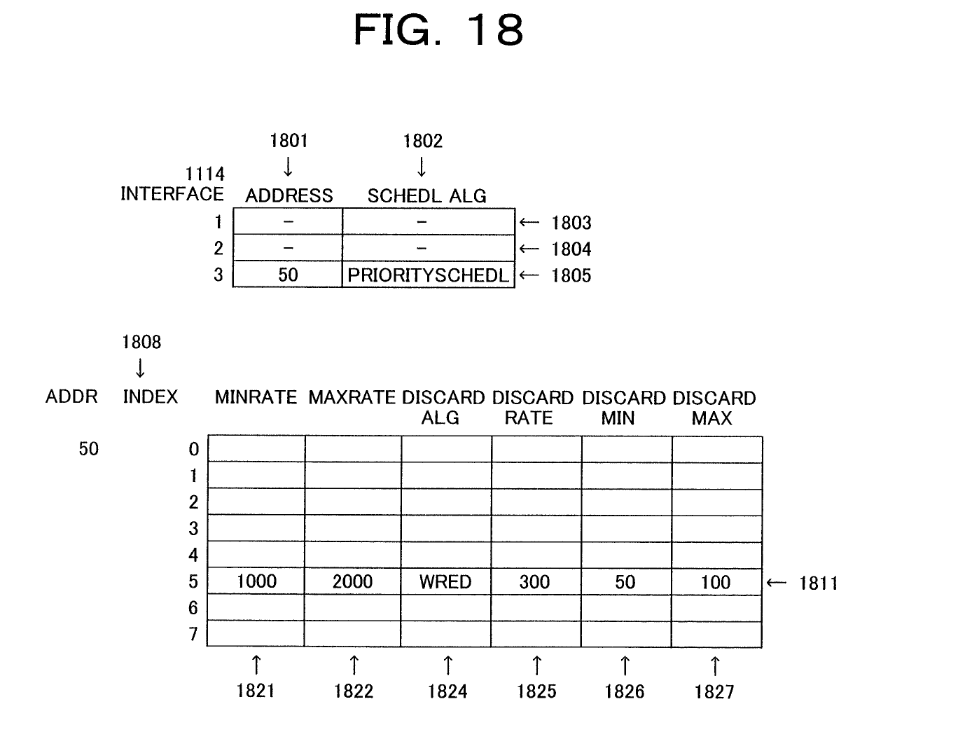

Then, the operation of the policy rule compiler 1103 will be explained with reference to FIG. 19. After the policy rule compiler 1103 starts to operate, it repeats the processing of steps 1901 to 1921 for all rules received at a time. In the first step 1901, the compiler judges whether there remains a rule that has not yet been processed after received. If such rule remains, the compiler goes to step 1902; if not, then the processing of the policy compiler 1103 terminates. In the step 1902, after the rule is converted into code, if same code exists in the policy rule table 1113, the compiler deletes it from the table or replaces it by null data.

In the step 1903, the compiler judges what is the type of the rule. If the rule is “Classification”, the compiler executes the classification instruction generating process 1911. If the rule is “Policing”, the compiler executes the policing instruction generating process 1912. If the rule is “QoSAction”, the compiler executes the QoS action instruction generating process 1913. If the rule is “Scheduling”, the compiler executes the scheduling configuration instruction generating process 1914. After executing the classification instruction generating process 1911, the policing instruction generating process 1912, or the QoS action instruction generating process 1913, the compiler goes to step 1921. After executing the scheduling configuration instruction generating process 1914, the compiler returns to the step 1901 and proceeds to next rule processing.

In the step 1921, the compiler enters the start address of the generated instruction into the Codep field 1317 for the rule in the policy source rule DB.

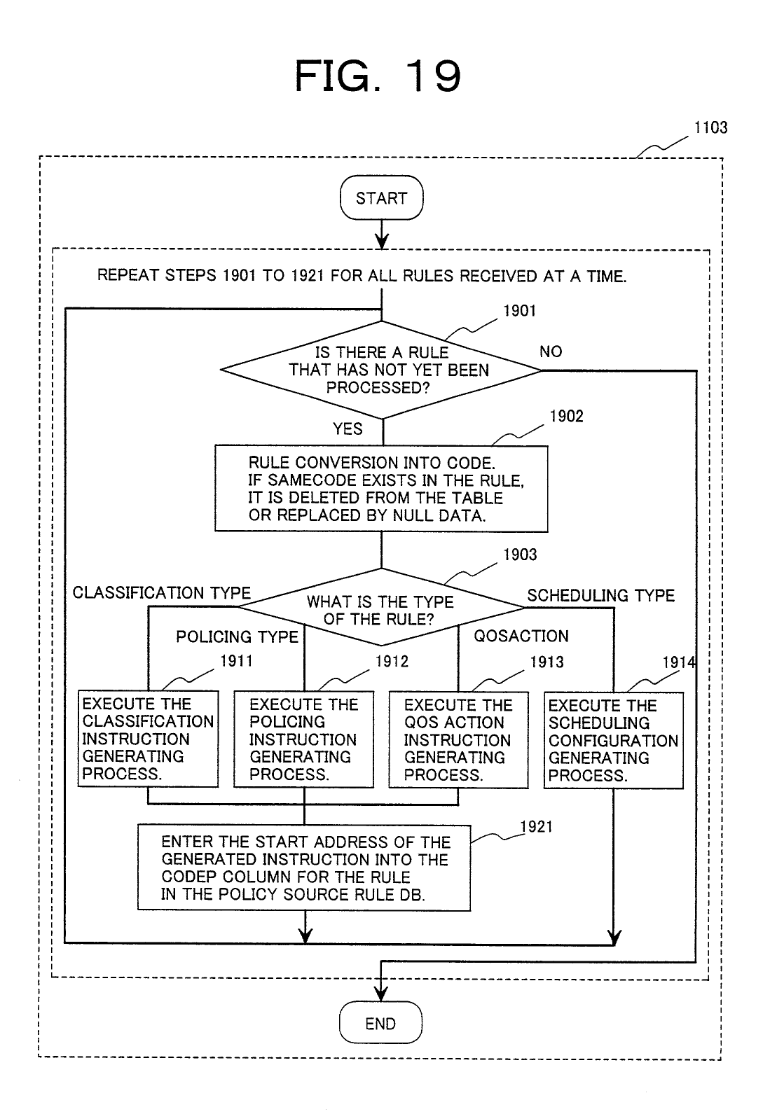

Next, the classification instruction generating process 1911 will be explained with reference to FIG. 20. The compiler starts the classification instruction generating process 1911 with step 2001 where it requests the specified interface to allocate a storage location into which the instruction can be stored. In next step 2002, if the instruction is the first one supplied to the interface, the compiler writes its start address into the element 1704 for the interface in the start instruction address table 1701. In the step 2003, the compiler copies the upper and lower ends of the source IP address of flow and associated port, the upper, the lower ends of the destination IP address of flow and associated port, and the DSCP value from the policy source rule DB shown in FIG. 13 to the corresponding fields of the instruction.

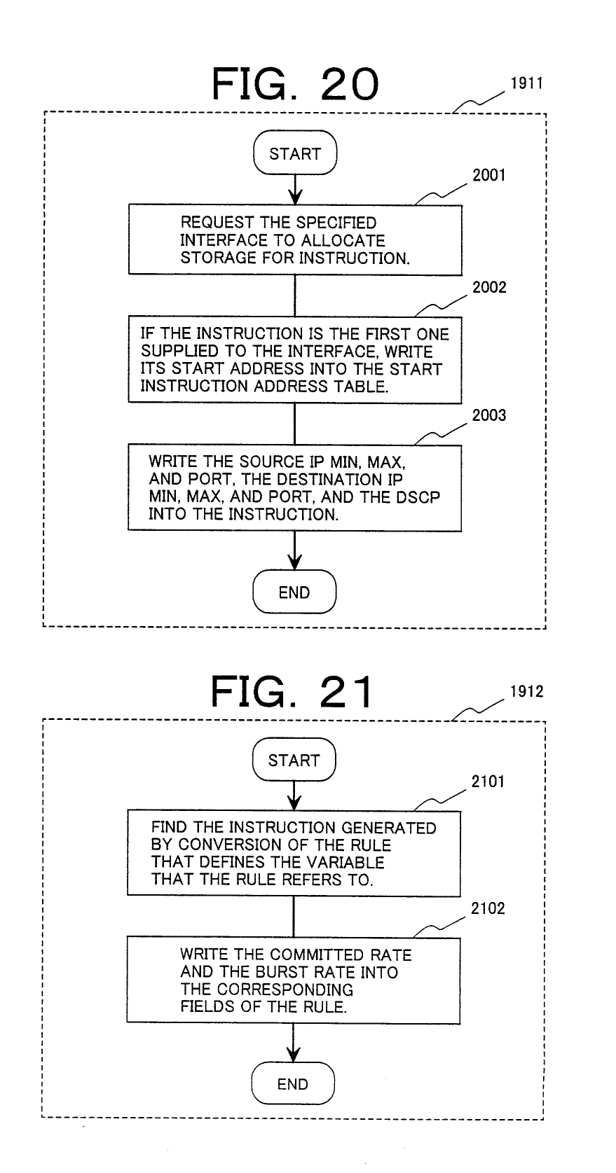

Then, the policing instruction generating process 1912 will be explained with reference to FIG. 21. The compiler starts the policing instruction generating process 1912 with step 2101 where it finds an instruction generated by conversion of the rule that defines the variable that the received rule refers to. Because a policing instruction is generated from a rule with the #2 rule identifier, the compiler looks up the rule ID #2 in the policy source rule DB 1111 and its condition field where the pointer indicates the table (B) (431). By referring to the table (B), the compiler finds that the received rule references the variable numbered 1. Then, the compiler refers to the variable definition table 1401 and finds that the rule of the #1 rule identifier defines the variable number 1 as indicated by the first line of the table. Then, the compiler refers to the Codep field 1317 for the rule ID #1 from which a classification instruction is generated in the policy source rule DB 111 and finds that the start address of the instruction is 90, thereby the compiler can identify the instruction.

In the next step 2102, the compiler copies the values in the max. average (Committed) rate field 432 and the burst rate field 433 in the table (B) pointed from the condition field of the policy source rule DB 1111 to the Committed rate field 1728 and the Burst rate field 1729 in the generated instruction.

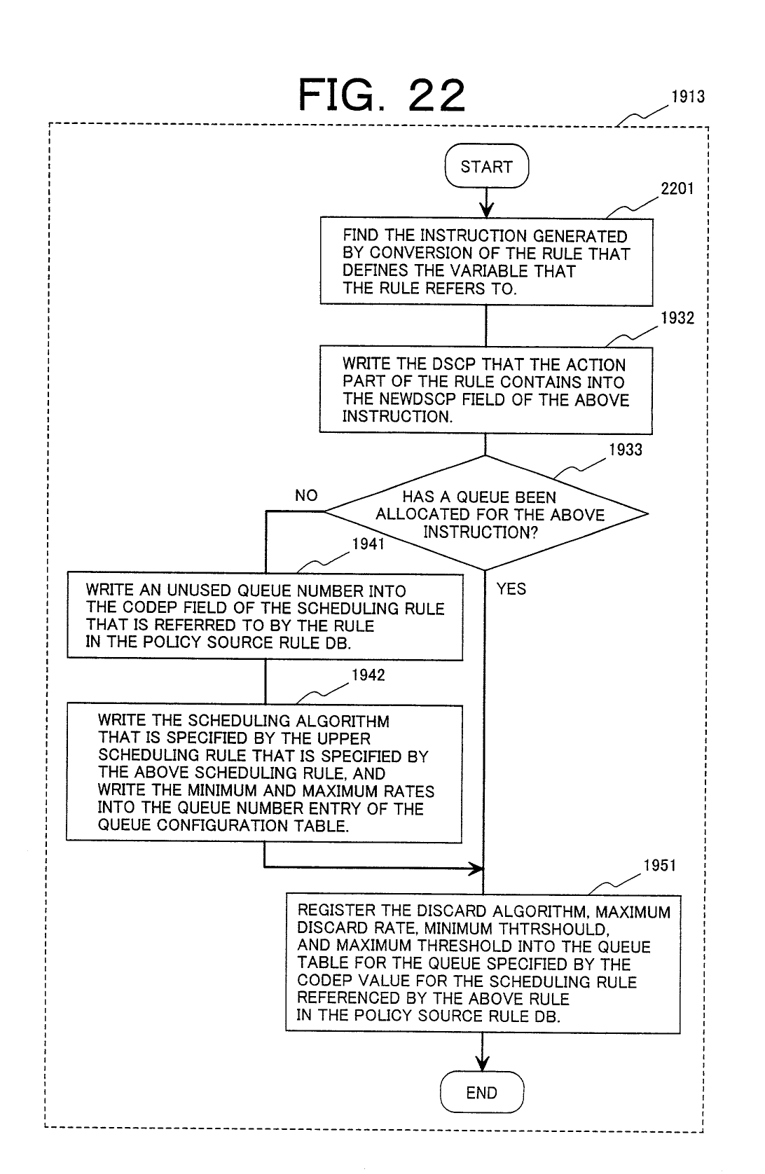

Then, the QoS action instruction generating process 1913 will be explained with reference to FIG. 22. The compiler starts the QoS action instruction generating process 1913 with step 2201 where it finds an instruction generated by conversion of the rule that defines the variable that the received rule refers to. How the compiler finds this instruction is as described above for the step 2101. Then, the compiler writes the DSCP value included in the action part of the received rule into the new DSCP field (New DSCP) 1731 of the above instruction. For a rule with the #3 rule identifier, which is assumed to have been received, the above DSCP value is “46” contained in the DSCP field of the Table (C).

In the next step 1933, the compiler judges whether a queue has been allocated for the above instruction. If a queue has been allocated for the above instruction, the compiler goes to step 1951; if not, the compiler goes to step 1941. In the step 1941, the compiler writes an unused queue number into the Codep field for the scheduling rule that the received rule refers to in the policy source rule DB 1111. In the next step 1942, the compiler writes the scheduling algorithm specified by the upper scheduling rule specified in the above scheduling rule, and the minimum and maximum rates into the queue configuration table 1114.

Specifically, for the #3 rule, the compiler copies the scheduling algorithm 463, namely PrioritySchedl from the table (E) into the scheduling algorithm field 1802 on the line for interface number 3 in the queue configuration table 1114. Moreover, it copies the minimum rate of 1000 (461) and the maximum rate of 2000 (462) from the table (E) into the minimum rate field 1821 and the maximum rate field 1822 on the line 1811 for queue number 5 in the interface-specific queue configuration table 1808.

In the step 1951, the compiler registers the appropriate values into the fields of discard algorithm 1824, maximum discard rate 1825, minimum threshold 1826, and maximum threshold 1827 on the line 1811 for queue number 5 in the interface-specific queue configuration table 1808 for the queue specified by the Codep 1317 value for the scheduling rule referenced by the received rule in the policy source rule DB.

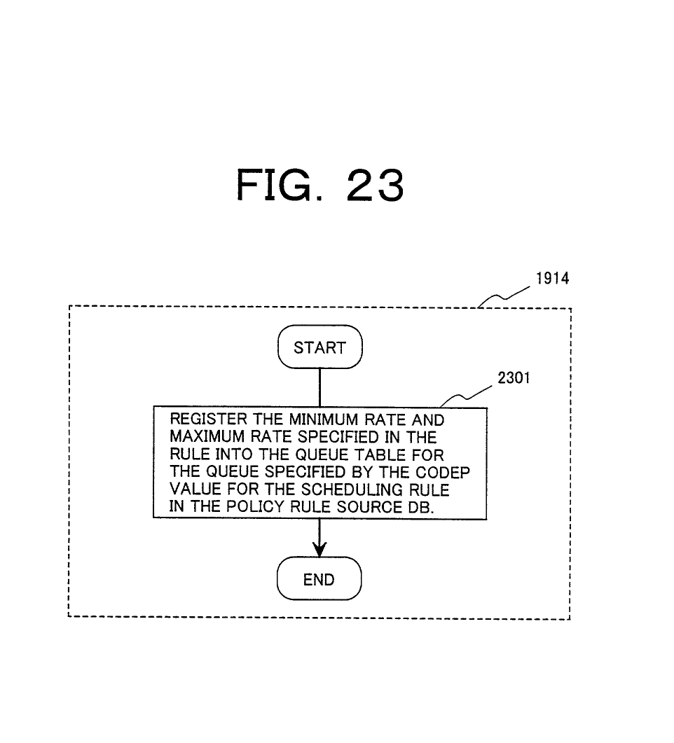

Next, the scheduling configuration generating process 1914 will be explained with reference to FIG. 23. In the step 2301 for the scheduling configuration generating process 1914, the policy compiler registers the minimum rate 461 and the maximum rate 462 specified in the rule into the interface-specific queue configuration table 1808, on the line 1811 for queue number 5 that is specified by the Codep 1317 value for the scheduling rule in the policy rule source DB.

The explanation of the preferred embodiment regarded as primary is now finished. In the following, modification in several aspects to the foregoing embodiment will be discussed.

A first aspect of modification is discussed. In the foregoing primary embodiment, the policy rule dependence analyzer 204 analyzes the relations between rules for dependence that is due to that a rule refers to a variable described in another rule. Such dependence is called flow dependence in the following references:

Y. Kaneda, et al., Global Array Data Flow Analysis Method; In the Transactions of the Information Processing Society of Japan, Vol. 28, No. 6, 1987, pp. 567-576.

J. R. Allen, et al., Conversion of Control Dependence to Data Dependence; In proceedings of international academic conference, The 10th Annual ACM Symposium on Principles of Programming Languages, 1983, pp. 177-189.

According to the above references, in addition to the flow dependence, two types of data dependence and control dependence, that is, output dependence and anti-dependence. The data dependence and control dependence defined in the above references are defined for programs described in procedure-oriented languages, whereas they can be defined for programs described in rule-oriented languages in the same way. In accordance with the definitions thus done, judgment is possible as to where there are data dependence and control dependence between a plurality of rules. If rules are found to have such dependence, the policy rule dependence analyzer 204 could analyze them and determine their transition closure based on the.

In addition to its role, the policy rule dependence analyzer 204 may take on the duty of the policy consistency checker 203, that is, the task to judge whether conditions are exclusive to detect inter-rule dependence if the conditions are not exclusive, so that the analyzer can analyze the rules also for dependence due to non-exclusive conditions. Although, in the foregoing primary embodiment, the policy rule dependence analyzer 204 need not analyze rules to detect output dependence, anti-dependence, and control dependence, some interface specification between the policy server 103 and the router 101 requires such analysis when rules are added, removed, or updated.

A second aspect of modification is discussed. In the foregoing primary embodiment, three commends, Deploy, Undeploy, and Redeploy are used for packet transmission from the policy server 103 to the router 101. These commands can be replaced by four commands Load, Deploy2, Undeploy2, and Unload. The format of the Load command is the same as the Deploy command format 2401. The format of the Deploy 2, Undeploy2, and Unload commands is the same as the Redeploy command format 2431. However, an interface number 2404 is not specified in the Load and Unload commands; i.e., the interface number field 2404 shall always be empty.

The policy server 103 sends the contents of a rule to the router 101 by issuing the Load command. The server also issues the Deploy2 command that requires that the rule identified by the rule identifier 2433, which has been stored into the router 101, takes effect on a specific interface. Therefore, the Deploy command function described in the foregoing embodiment is implemented by the combination of the Load command and the Deploy2 command. The server may issue the Undeploy2 command that requires that the rule identified by the rule identifier 2433, which now takes effect on a specific interface, will not take effect on the interface. Even when the Undeploy2 command is issued, the rule is not removed from the router. Furthermore, the server issues the Unload command to remove the rule specified by the rule identifier 2433 from the router 101.

The use of these commands can explicitly specify the removal of a rule from the router 101, thus enabling efficient management of the resources on the router 101. This can prevent such an error from occurring that the router removes a rule by its self-decision and even if the policy server issues a Redeploy command for the rule, the Redeploy command is disabled.

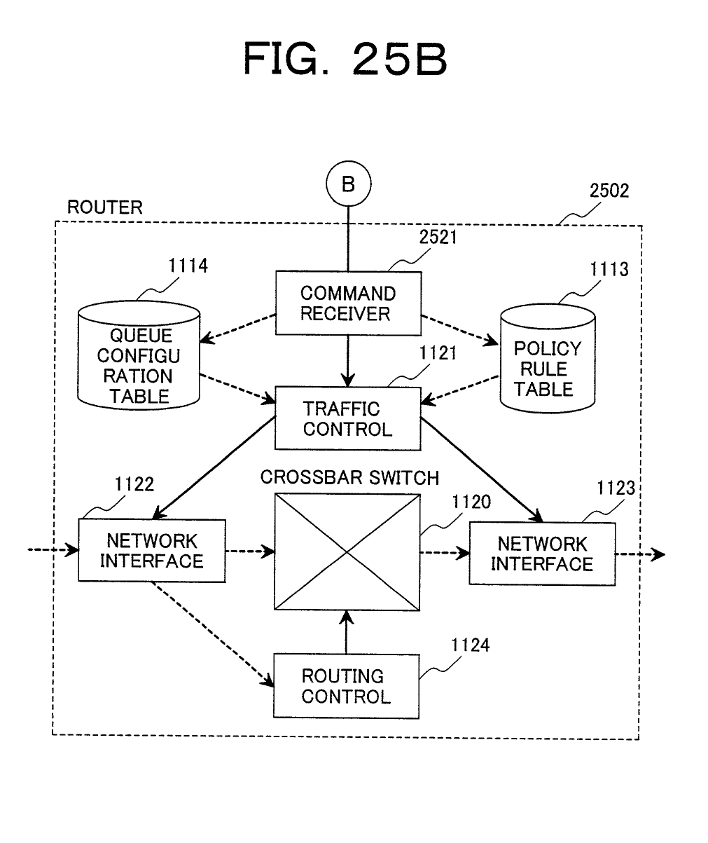

A third aspect of modification is discussed. In the foregoing primary embodiment, when transferring a plurality of rules to the router 101, the whole rules must be transferred even if they are almost the same except some minor difference. With a case where a plurality of rules with only the label variable value difference are transferred taken into consideration, a Deploy2 command may be created, which will be detailed below, so that data quantity to be transferred can be reduced. The Deploy2 command will be explained with reference to FIG. 26. The Deploy2 command 2601 requires that a rule previously stored into the router is duplicated as a new rule with only the label variable that is defined or used in the rule being replaced by a new value and the new rule is stored into the router. The Op code field 2602 contains “Deploy2” indicating that this data is a Deploy2 command. The value in the rule ID field 2603 indicates the rule identifier of the rule included in the Deploy2 command. The value in the interface field 2604 indicates the number of the network interface on which the Deploy2 command is to act. The value in the old rule ID field 2605 indicates the rule identifier of the rule that is duplicated. The value in the new label field 2606 indicates the value of the label variable to replace the existing label variable value.

Although only one label variable value is changed in this example of the Deploy 2 command 2601, if a plurality of label variables are defined or used in the rule to be duplicated and these variables are replaced, the number of the new label fields of the command may be increased accordingly. If value replacement other than the label variable is required, similarly, additional fields may be provided for the replacement.

As compared with using the Deploy command 2401, data quantity to be transferred from the policy server 103 to the router 101 can be reduced by using the Deploy2 command 2601. There is relatively low probability of using similar rules if macro rules to the interface specification between the policy server 103 and the router 101 are used. However, similar rules are often used if subdivision rules are used as in the present embodiment and therefore the use of the Deploy2 command is quite effective.

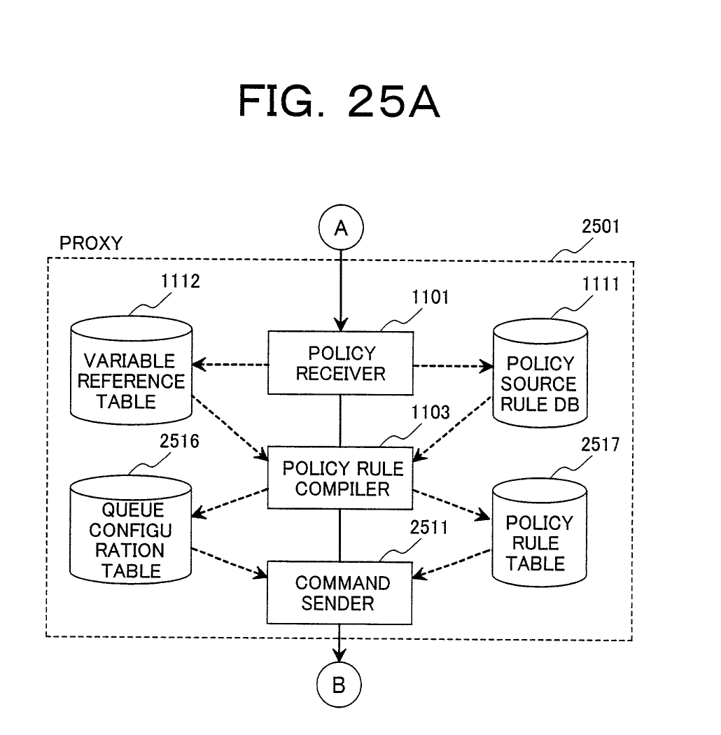

A fourth aspect of modification is discussed. In the foregoing primary embodiment, it is assumed that the router 101 has the capability of directly interpreting commands sent from the policy server 103. If an existing router is connected to the server, however, the router may not have this capability. In this case, it is advisable to use a proxy 2501 and a router 2502 shown in FIG. 25 instead of the router 101 shown in FIG. 11. The configuration shown in FIG. 25 differs from that shown in FIG. 11 only in the following respects. In the proxy 2501, a queue configuration table 2516 and a policy rule table 2517 are provided on main storage or a hard disk with the contents of these tables being equivalent to those of the queue configuration table 1114 and the policy rule table 1113. A command sender 2511 sends the contents of the queue configuration table 2516 and the policy rule table 2517 to the router 2502. In the router 2502, the data received from the proxy 2501 is stored into the queue configuration table 1114 and the policy rule table 1113. By attaching the proxy to the router in this way, the present invention can be applied to routers that cannot interpret commands sent from the policy server 103, particularly, routers that have already been put into operation.

A fifth aspect of modification is discussed. In the foregoing primary embodiment, the policy compiler 1103 merges a plurality of rules into one rule in form that they can be executed, but does not execute rule disassembly. This is because the rules are sufficiently subdivided ones to the interface specification between the policy server 103 and the router 101. However, if the interface specification prescribes that macro rules be used and subdivision form rules can only be executed on the router, the policy rule compiler 1103 need to disassemble received rules. If, for example, the interface specification prescribes that rules be formatted in form 1708 and the form that the rules can be executed on the router is as shown in FIG. 4, the compiler can disassemble the rules by introducing a label variable into the rules with the variable value of 1, 2, or 3.

Rule disassembly can also apply in the following case. If the operator enters rules in the form 1708 and the interface specification prescribes that subdivision rules be used as in the foregoing embodiment, it is advisable to insert a program for rule disassembly between the policy rule dependence analyzer 204 and the policy scheduler 205 on the policy server 103.

A sixth aspect of modification is discussed. In the foregoing primary embodiment, when a rule is updated, the policy compiler 1103 deletes the instruction corresponding to the rule and then generates a replacement instruction. In this method, however, the rule temporalily does not take effect. To avoid this interruption of service, taking the following method is preferable.

To make the service continue during the update of the rule, it is advisable to skip the step 1902 in FIG. 19 (that is, the compiler jumps to the step 1903 if the compiler has a rule to be processed in the step 1901) and generate an instruction, but keep it ineffective during the steps 1911 to 1914. The instruction is made effective after the completion of the step 1921 and the step 1914. When replacing the existing instruction by the generated instruction, making the existing instruction ineffective and making the generated instruction effective are performed at the same time. Thereby, the service interruption can be avoided.

To update a plurality of rules at the same time, the following method should be used. Create a switch event that is registered into the policy scheduling table 213 as an additional item to the table. With the switch event, the same next time 723 and time 724 as for the deploy event are registered. Immediately after the policy scheduler 205 generates all deploy events of the items entered in the step 803, the switch event is generated. Create a Switch command as one of the commands to be sent from the policy server 103 to the router 101. The format of the Switch command is the same as the Redeploy command format 2431, but the rule ID 2433 field of the former empty shall remain empty. When the policy sender 206 detects a switch event in the step 1004, it sends the Switch command in which a network interface number is specified to the specified router.

On the router 101, the instruction generated by the policy rule compiler 1103 is kept ineffective before it receives the Switch command. When the policy receiver 1101 detects the Switch command in the step 1502, it requests the policy rule compiler 1103 to make the instructions generated by the compiler take effect on the specified network interface and at the same time make the existing instruction, if any, to be replaced by any generated instruction ineffective. In order to add instructions generated in advance at a time when some instruction may replace the existing instruction, it is advisable to use double buffering for part or all of the storage for instructions. Switching between the two buffers occurs when requested.

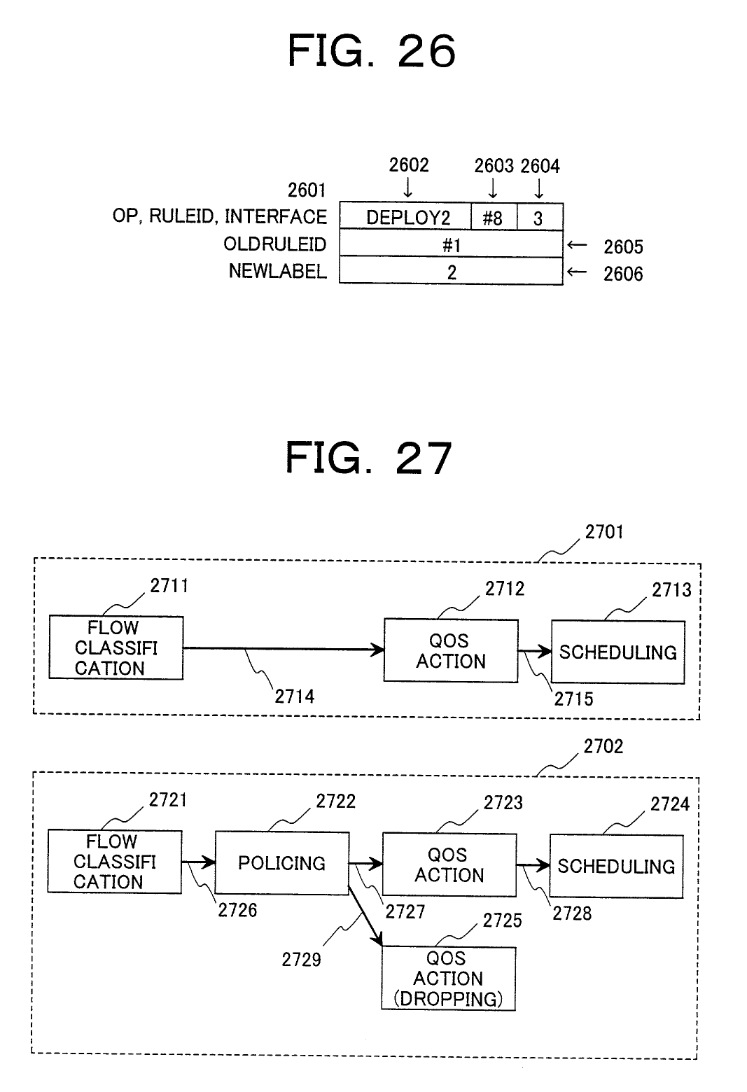

A seventh aspect of modification is discussed. In the foregoing primary embodiment, it is assumed that the operator enters all rules one by one, but this input of subdivision rules is not always easy. To enable the operator to enter rules more easily, simpler input templates should be prepared as follows. Combine rules for standard services of DiffServ into templates that allow the operator to define services for a specific flow by filling the template with required parameters. This example of embodiment will be explained below with reference to FIG. 27.

A template 2701 is for simple services without policing. The template 2701 comprises a classification rule 2711, a QoS action rule 2712, and a scheduling rule 2713 and these rules are connected by arrows 2714 and 2715. The template 2701 is a combination of the template 301, the template 321, and the template 341. The arrow 2714 indicates a label variable value by which the classification rule 2711 and the QoS action rule 2712 are interrelated. In other words, the arrow 2714 represents variable value matching between the Label field 307 of the template 301 and the Label field 323 of the template 321. The arrow 2715 represents variable value matching between the Label field 327 of the template 321 and the Label field 343 of the template 341.

A template 2702 is for services for which packets in excess of contract bandwidth are discarded. The template 2702 comprises a classification rule 2721, a policing rule 2722, a QoS action rule 2723, a scheduling rule 2724, and a QoS rule 2725 and these rules are connected by arrows 2726, 2727, 2728, and 2729. In the QoS action rule 2725, predetermined action “drop” that means discard is specified.

Although the preferred embodiment described above concerns rules for QoS control, the method of the invention is applied to rules of other functions when the rules are downloaded from the policy server to a network node such as a router. The invention can be applied to, for example, switching and routing control rules, rules such as Network Address Translation (NAT) for converting information on flow source and destination included in packets and addresses included in payload, rules for executing calculation based on the information included in payload and writing the result into the payload, rules that take effect on a plurality of packets and generate new packets from the input information included in the payload of the packets.

The use of the network control method of the present invention enables network operation with minimum policy rules and data sets to be converted when the policy rules are converted into those in form that they can be executed on the router by using the means of analyzing policy rules for dependence of policy rule data on another policy rule data.

When the policy server is requested to send a policy rule to the router, it can transfer only the identifier of the policy rule to the router instead of transferring the contents thereof by using the means of judging whether the policy rule has been stored in the router. In this way, the data quantity to be transferred can be minimized. Therefore, the present invention enables: minimizing traffic congestion in a network; minimizing the rule download time and the time required for policy rule conversion; eliminating policy control interruption or minimizing the interruption time; and preventing routers from being put under overload.

While the invention has been particularly shown and described with reference to preferred embodiments thereof, it will be understood by those skilled in the art that the foregoing and other changes in form and details can be made therein without departing from the spirit and scope of the invention.

What is claimed is:

1. A method of transmitting a plurality of policy rules, each of which describes a condition and an action, from a policy server to a network node that is connected to the policy server via a network, the method comprising the steps of:
assigning the plurality of policy rules with their identifiers;
transmitting the policy rules with their assigned identifier to said network node: and
detecting policy rules that depend on a newly entered policy rule or on any of which a newly entered policy rule depends when transmitting a new policy rule or rules to said network node as additional one or ones,
wherein, with regard to the policy rules that depend on a new policy rule or on any of which a new policy rule depends, detected by said detection step, if the policy rule has not been transmitted to said network node, the identifier thereof and the condition and action described therein are transmitted to said network node; if the policy rule has been transmitted to said network node, the identifier thereof is transmitted to said network node, but the condition and action described therein are not transmitted.

2. A method of transmitting a plurality of policy rules according to claim 1, wherein, with regard to the policy rules that depend on a new policy rule or on any of which a new policy rule depends, detected by said detection step, if the policy rule has not been transmitted to said network node, the identifier thereof, the condition and action described therein, and a first instruction that specifies network interface information on said network node to put the policy rule into action are transmitted to said network node; if the policy rule has been transmitted to said network node, the identifier thereof and a second instruction that specifies network interface information on said network node to put the policy rule into action are transmitted to said network node.

3. A method of transmitting a plurality of policy rules according to claim 1, further comprising the steps of:
retaining the policy rules transmitted to said network node in storage of said policy server; and
checking the transmitted policy rules retained in said storage to see whether the policy rules that depend on a new policy rule or on any of which a new policy rule depends, detected by said detection step, have been transmitted to said network node.

4. A method of transmitting a plurality of policy rules according to claim 1, wherein said step of detecting policy rules that depend on a new policy rule or on any of which a new policy rule depends detects a policy rule that references a variable defined in said newly entered policy rule or a policy rule that defines a variable that is used as a condition in said newly entered policy rule.

5. A method of transmitting a plurality of policy rules according to claim 1, wherein said network node is connected to a proxy server that converts the plurality of policy rules transmitted from said policy server into those in form that they can be executed on said network node and said network node receives the converted rules in this form.

6. A method of transmitting a plurality of policy rules, each of which describes a condition and an action, from a policy server to a network node that is connected to the policy server via a network, the method comprising the steps of:
generating a plurality of policy rules:
assigning the policy rules their identifier;
transmitting part of or all the policy rules with their assigned identifier to said network node;
seeing whether the condition described in a policy rule to be removed is exclusive with the conditions described in said plurality of policy rules when removing at least one of the policy rules transmitted to said network node;
transmitting a request to remove a policy rule with its identifier that is specified by the operator to said network node, provided the condition of the policy rule is exclusive.

7. A method of transmitting a plurality of policy rules from a policy server to a network node that is connected to the policy server via a network, the method comprising the steps of:
transmitting the plurality of policy rules to said network node;
transmitting to said network node a specific code and an instruction that specifies a new variable to override a variable that has been defined or used as a condition in at least one of said transmitted policy rules when updating said variable,
wherein said specific code represents an instruction to copy a policy rule including said variable to change and replace the variable in the thus produced policy rule copy by said new variable.
